(19) United States
(12) Patent Application Publication
(10) Pub. No.: US 2009/0029283 A1
(43) Pub. Date: Jan. 29, 2009

(54) MANUFACTURING METHOD OF ALUMINUM SUPPORT FOR PLANOGRAPHIC PRINTING PLATE MATERIAL, ALUMINUM SUPPORT FOR PLANOGRAPHIC PRINTING PLATE MATERIAL, AND PLANOGRAPHIC PRINTING PLATE MATERIAL

(75) Inventor: Hiroshi Takagi, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA MEDICAL & GRAPHIC, INC., Tokyo (JP)

(21) Appl. No.: 11/814,699

(22) PCT Filed: Dec. 16, 2005
(86) PCT No.: PCT/JP2005/023119

§ 371 Date: Jul. 25, 2007

(30) Foreign Application Priority Data
Feb. 4, 2005 (JP) 2005028651

(51) Int. Cl. G03C 1/77; C25D 11/16

(52) U.S. Cl. 430/270.1; 205/214; 428/141

(57) ABSTRACT

Disclosed is a manufacturing method of an aluminum support for a planographic printing plate material, which comprises electrolytically surface-roughening an aluminum plate in an electrolytic solution containing mainly hydrochloric acid at current density of from 35 to 150 A/dm² and at a quantity of electricity of from 600 to 1500 A·second/dm², employing AC, etching the surface-roughened aluminum plate so that the dissolution amount of the aluminum is from 3 to 5 g/m², electrolytically surface-roughening the resulting aluminum plate in an electrolytic solution containing mainly hydrochloric acid at current density of from 15 to 30 A/dm² and at a quantity of electricity of from 100 to 400 A·second/dm², employing AC, desmutting smut produced on the aluminum plate in an acidic solution containing mainly phosphoric acid, so that the amount of the smut remaining undissolved is from 0.05 to 0.3 g/m², and anodizing the desmutted aluminum plate in that order.

### FIELD OF THE INVENTION

The present invention relates to a method of an aluminum support used in a planographic printing plate material, an aluminum support for a planographic printing plate material manufactured according to the method, and a planographic printing plate material using the aluminum support.

### TECHNICAL BACKGROUND

Recently, in a plate-making process of a printing plate for off-set printing, a CTP has been developed in which digital image data can be directly written in a light sensitive planographic printing plate material employing laser, and has been practically used.

Among them, a printing plate material comprising an aluminum support and provided thereon, an image formation layer are used in printing industries in which a relatively high printing durability is required.

As the aluminum support, an aluminum plate subjected to surface-roughening treatment and anodization treatment is generally used.

As a method of surface roughening an aluminum plate, electrolytically surface roughening is known whereby a uniform convexo-concave surface is easily obtained. Electrolytically surface roughening has been mainly employed which is carried out particularly in an aqueous hydrochloric acid or nitric acid solution.

Various structures described below of an aluminum support are known as surface structures to improve printability.

There are known various surface structures, for example, a triple structure disclosed in Japanese Patent O.P.I. Publication No. 8-300844 which is comprised of a large wave, a medium wave and a small wave, an aperture diameter of the medium and small waves being specified; a double structure disclosed in Japanese Patent O.P.I. Publication Nos. 11-99758 and 11-167207 which is comprised of a large wave and a small wave, an aperture diameter of the small wave being specified; a double structure disclosed in Japanese Patent O.P.I. Publication No. 11-167207 which is comprised of large and small concaves (pits), fine protrusions being adding thereto; a double structure disclosed in Japanese Patent Publication No. 2023476 in which the aperture is specified; a double structure in which a surface smoothness is specified (see Patent Document 1 below); and a structure in which the ratio of the aperture diameter of plural pits overlapped by plural electrolytically surface roughening treatments is specified (see Patent Document 2 below).

Further, there is known electrolytically surface roughening which is carried out employing plural electrolytic tanks to which alternating currents with different waveforms are supplied (see Patent Document 3 below). However, planographic printing plate materials comprising these aluminum supports for planographic printing plate material and provided thereon, an image formation layer have problems in that printing durability, particularly printing durability of small dot images is insufficient, printing ink accumulates during printing at portions corresponding to non-image portions of the blanket of a press (blanket contamination) to produce contamination at non-image portions, and it is necessary to wash the blanket frequently in order to prevent such contamination.

Further, there is problem in these planographic printing plate materials that contamination is produced at non-image portions when printing restarts after printing is suspended for rest, etc. (background contamination after suspension of printing).

Particularly in the printing, in which VOC-free printing ink (“VOC” means volatile organic compounds) is employed for environmental reasons recently, they are not enough to overcome the above problems of insufficient printing durability, blanket contamination or background contamination after suspension of printing.

### [Patent Document 1]

### Japanese Patent O.P.I. Publication No. 8-300843

### [Patent Document 2]

### Japanese Patent O.P.I. Publication No. 10-35133

### [Patent Document 3]

### Japanese Patent O.P.I. Publication No. 11-208138

### DISCLOSURE OF THE INVENTION

### Problems to be Solved by the Invention

An object of the invention is to provide a planographic printing plate material providing high printing durability, high resistance to blanket contamination, and high resistance to background contamination after suspension of printing, an aluminum support for a planographic printing plate material providing such a planographic printing plate material, and a method of manufacturing the aluminum support, and to provide a planographic printing plate material providing high printing durability, high resistance to blanket contamination, and high resistance to background contamination after suspension of printing, particularly when printing is carried out employing a VOC-free printing ink, an aluminum support for a planographic printing plate material providing such a planographic printing plate material, and a method of manufacturing the aluminum support.

### Means for Solving the Above Problems

The above object of the invention can be attained by the fooling constitutions.

1. A manufacturing method of an aluminum support for a planographic printing plate material, the method comprising the steps of (1) etching a surface on one side of an aluminum plate with an alkali solution, (2) neutralizing the etched aluminum plate surface with an acidic solution, (3) electrolytically surface-roughening the neutralized aluminum plate in an electrolytic solution containing mainly hydrochloric acid at current density of from 35 to 150 A/dm² and at a quantity of electricity of from 600 to 1500 A·second/dm², employing alternating current, (4) carrying out the following step (4A) or (4B):

(4A) etching the surface-roughened aluminum plate with an alkali solution so that the dissolution amount of the aluminum is from 3 to 5 g/m², and then neutralizing the etched aluminum plate surface with an acidic solution or

(4B) etching the surface-roughened aluminum plate with an acidic solution containing mainly phosphoric acid so that the dissolution amount of the aluminum is from 3 to 5 g/m², (5) electrolytically surface-roughening the resulting aluminum plate in an electrolytic solution mainly containing hydrochloric acid at current density of from 15 to 30 A/dm² and at a quantity of electricity of from 100 to 400 A·second/dm², employing alternating current, (6) desmutting smut produced on the aluminum plate surface during the step (5) in an acidic solution containing mainly phosphoric acid, so that the amount of smut remaining undissolved is from 0.05 to 0.3 g/m², and (7) anodizing the desmutted aluminum plate, in that order, whereby a roughened surface is formed.

2. The manufacturing method of an aluminum support for a planographic printing plate material of item 1 above, wherein the electrolytic solution containing mainly hydrochloric acid in steps (3) and (5) is an electrolytic solution containing a hydrochloric acid concentration of from 5 to 20 g/liter, an aluminum ion concentration of from 0.5 to 15 g/liter and an acetic acid concentration of 0 to 20 g/liter, whose temperature is from 15 to 40° C.

3. The manufacturing method of an aluminum support for a planographic printing plate material of item 1 or 2 above, wherein the electrolytic solution containing mainly phosphoric acid in step (6) is an electrolytic solution containing a phosphoric acid concentration of from 25 to 450 g/liter and an aluminum ion concentration of from 0.01 to 10 g/liter, whose temperature is from 30 to 80° C.

4. The manufacturing method of an aluminum support for a planographic printing plate material of any one of items 1 through 3 above, wherein in step (1), the alkali solution contains 0.5 to 6 g/liter of NaOH, and the dissolution amount of the aluminum is from 2.5 to 5 g/m².

5. The manufacturing method of an aluminum support for a planographic printing plate material of any one of items 1 through 4 above, wherein the anodizing in step (7) is carried out in an acidic solution containing mainly sulfuric acid to form an anodization film with a coated amount of from 1 to 4 g/m².

6. The manufacturing method of an aluminum support for a planographic printing plate material of any one of items 1 through 5 above, wherein after the step (7), the anodized aluminum plate is subjected to sealing treatment or hydrophilization treatment.

7. An aluminum support manufactured according to the manufacturing method of an aluminum support for a planographic printing plate material of any one of items 1 through 6 above.

8. The aluminum support of item 7 above, wherein the aluminum support has a roughened surface with an arithmetic average roughness (Ra) of from 0.40 to 0.60 μm.

9. A planographic printing plate material comprising the aluminum support for a planographic printing plate material of item 7 or 8 above, and provided thereon, an image formation layer.

10. The planographic printing plate material of item 9 above, wherein the image formation layer is a thermosensitive image formation layer.

11. The planographic printing plate material of item 9 above, wherein the image formation layer is a photopolymerizable image formation layer.

12. The planographic printing plate material of any one of items 9 through 11 above, wherein the image formation layer is capable of being subjected to on-press development.

### EFFECTS OF THE INVENTION

The present invention can provide a planographic printing plate material providing high printing durability, high resistance to blanket contamination, and high resistance to background contamination after suspension of printing, an aluminum support for a planographic printing plate material providing such a planographic printing plate material, and a method of manufacturing the aluminum support, and to provide a planographic printing plate material providing high printing durability, high resistance to blanket contamination, and high resistance to background contamination after suspension of printing, particularly when printing is carried out employing a VOC-free printing ink, an aluminum support for a planographic printing plate material providing such a planographic printing plate material, and a method of manufacturing the aluminum support.

### PREFERRED EMBODIMENTS OF THE INVENTION

The present invention will be explained in detail below.

The present invention is a manufacturing method of an aluminum support for a planographic printing plate material, and the method is characterized in that it comprises the steps of (1) etching a surface on one side of an aluminum plate with an alkali solution, (2) neutralizing the etched aluminum plate with an acidic solution, (3) electrolytically surface-roughening the neutralized aluminum plate in an electrolytic solution containing mainly hydrochloric acid at current density of from 35 to 150 A/dm² and at a quantity of electricity of from 600 to 1500 A·second/dm², employing alternating current, (4) carrying out the following (4A) or (4B):

(4A) etching the surface-roughened aluminum plate with an alkali solution so that the dissolution amount of the aluminum is from 3 to 5 g/m², and then neutralizing the etched aluminum plate surface with an acidic solution or

(4B) etching the surface-roughened aluminum plate with an acidic solution containing mainly phosphoric acid so that the dissolution amount of the aluminum is from 3 to 5 g/m², (5) electrolytically surface-roughening the resulting aluminum plate in an electrolytic solution containing mainly hydrochloric acid at current density of from 15 to 30 A/dm² and at a quantity of electricity of from 100 to 400 A·second/dm², employing alternating current, (6) desmutting smut produced on the aluminum plate surface during the step (5) in an acidic solution containing mainly phosphoric acid, so that the amount of the smut remaining undissolved is from 0.05 to 0.3 g/m², and (7) anodizing the desmutted aluminum plate, in that order, whereby a roughened surface is formed.

In the invention, an aluminum plate, subjected particularly to the two surface roughening steps as described above, i.e., the steps (3) and (4) and the steps (5) and (6), provides an aluminum support for a planographic printing plate material providing high printing durability, high resistance to blanket contamination, and high resistance to background contamination after suspension of printing.

### (Support)

As the aluminum support of the invention for a planographic printing plate material, an aluminum plate is used. The aluminum plate is a pure aluminum plate or an aluminum alloy plate.

As the aluminum alloy, there can be used various ones including an alloy of aluminum and a metal such as silicon, copper, manganese, magnesium, chromium, zinc, lead, bismuth, nickel, titanium, sodium or iron. Further, an aluminum plate manufactured by rolling can be used.

A regenerated aluminum plate obtained by rolling aluminum regenerated from scrapped or recycled materials, which has recently spread, can be also used.

In the invention, the aluminum plate preferably contains 0.1 to 0.4% by weight of Mg in view of contamination resistance or printing durability.

In the invention, the aluminum plate is subjected to etching by an alkali solution as described in step (1) above as degreasing treatment for removing rolling oil on the aluminum surface prior to the surface roughening.

The etching by an alkali solution as described in step (1) can remove contaminations or oxidation film other than rolling oil.

The alkali solution is preferably an aqueous sodium hydroxide solution.

Regarding the etching, the dissolution amount of the aluminum is preferably from 2.5 to 5 g/m², in view of uniform roughened surface formation, uniform etching amount or reduction of waste solution.

The aqueous sodium hydroxide solution has a sodium hydroxide concentration of preferably from 0.5 to 6% by weight.

The temperature of the solution is not specifically limited, and can be adjusted, taking sodium hydroxide concentration and the etching time, so that the aluminum dissolution amount is that described above.

As the etching method, there is a method in which an aluminum plate is immersed in an alkali solution, or a method in which an aluminum plate is sprayed with an alkali solution, employing spray nozzles. The immersing method is preferred in dissolving uniformly aluminum.

After etching by an alkali solution, the aluminum plate is preferably washed with water.

Since smut (deposit such as aluminum hydroxide) is produced on the surface of the aluminum plate after etching by an alkali solution, the aluminum plate surface is neutralized in an acidic solution as described in step (2) above.

As the acidic solution, an aqueous solution of phosphoric acid, nitric acid, sulfuric acid, chromic acid, or a mixture thereof can be employed, and an aqueous nitric acid solution is preferred.

The nitric acid solution has a nitric acid concentration of from 1 to 10% by weight, the temperature is preferably from 15 to 30° C., and neutralization time is from 5 to 30 seconds.

As the neutralization method, there is an immersing method or spraying method, and the immersing method is preferred. After neutralization, water washing is preferably carried out.

Subsequently, surface roughening treatment is carried out. In the invention, electrolytic surface roughening treatment is carried out in an electrolytic solution containing hydrochloric acid as a main component, employing an alternating current. However, prior to the electrolytic surface roughening treatment, pre-surface roughening treatment such as an electrolytic surface roughening which is carried out in an electrolyte solution containing nitric acid as a main component or mechanical surface roughening treatment may be carried out.

Though there is no restriction for the mechanical pre-surface roughening treatment, a brushing roughening method and a honing roughening method are preferred.

The brushing roughening method is carried out by rubbing the surface of the plate with a rotating brush with a brush hair with a diameter of 0.2 to 0.8 mm, while supplying slurry in which volcanic ash particles with a particle size of 10 to 100 μm are dispersed in water to the surface of the plate.

The honing roughening method is carried out by ejecting obliquely slurry with pressure applied from nozzles to the surface of the plate, the slurry containing volcanic ash particles with a particle size of 10 to 100 μm dispersed in water. Surface roughening can be also carried out by laminating the plate surface with a sheet on the surface of which abrading particles with a particle size of from 10 to 100 μm has been coated at intervals of 100 to 200 μm and at a density of 2.5×10³ to 10×10³/cm², and then applying pressure to the laminated sheet to transfer the roughened pattern of the sheet, whereby the plate surface is roughened.

After the plate has been roughened mechanically, it is preferably dipped in an acid or an aqueous alkali solution in order to remove abrasives and aluminum dust, etc. which have been embedded in the surface of the support. Examples of the acid include sulfuric acid, persulfuric acid, hydrofluoric acid, phosphoric acid, nitric acid and hydrochloric acid, and examples of the alkali include sodium hydroxide and potassium hydroxide. Among those mentioned above, an aqueous solution of alkali chemicals such as sodium hydroxide is preferably used. The dissolution amount of aluminum in the plate surface is preferably 0.5 to 5 g/m². After the plate has been dipped in the aqueous alkali solution, it is preferable for the plate to be dipped in an acid such as phosphoric acid, nitric acid, sulfuric acid and chromic acid, or in a mixed acid thereof, for neutralization.

In the pre-electrolytic surface roughening treatment carried out in the electrolytic solution containing nitric acid, voltage applied is generally from 1 to 50 V, and preferably from 10 to 30 V.

The current density used can be selected from the range from 10 to 200 A/dm², and is preferably from 20 to 100 A/dm². The quantity of electricity can be selected from the range of from 100 to 5000 C/dm², and is preferably 100 to 2000 C/dm². The temperature during the electrolytic surface roughening treatment may be in the range of from 10 to 50° C., and is preferably from 15 to 45° C. The nitric acid concentration in the electrolytic solution is preferably from 0.1 to 5% by weight. It is possible to optionally add, to the electrolytic solution, nitrates, chlorides, amines, aldehydes, phosphoric acid, chromic acid, boric acid, acetic acid, oxalic acid or aluminum ion.

After the plate has been subjected to electrolytic surface roughening treatment in the electrolytic solution containing nitric acid, it is preferably dipped in an acid or an aqueous alkali solution in order to remove abrasives and aluminum dust, etc. which have been embedded in the plate surface. Examples of the acid include sulfuric acid, persulfuric acid, hydrofluoric acid, phosphoric acid, nitric acid and hydrochloric acid, and examples of the alkali include sodium hydroxide and potassium hydroxide. Among those mentioned above, an aqueous alkali solution is preferably used.

The dissolution amount of aluminum in the plate surface is preferably 0.5 to 5 g/m². After the plate has been dipped in the aqueous alkali solution, it is preferable for the plate to be dipped in an acid such as phosphoric acid, nitric acid, sulfuric acid and chromic acid, or in a mixed acid thereof, for neutralization.

In the invention, electrolytically surface roughening is carried out in an electrolytic solution mainly containing hydrochloric acid, employing alternating current.

The electrolytically surface roughening employing alternating current in an electrolytic solution containing mainly hydrochloric acid comprises two steps, a first step and a second step. The first step is the electrolytically surface-roughening employing alternating current in an electrolytic solution containing mainly hydrochloric acid at current density of from 35 to 150 A/dm² and at a quantity of electricity of from 600 to 1500 A·second/dm² as described in step (3) above. The second step is the electrolytically surface-roughening employing alternating current in an electrolytic solution containing mainly hydrochloric acid at current density of from 15 to 30 A/dm² and at a quantity of electricity of from 100 to 400 A·second/dm² as described in step (5) above.

After the step (3), the step (4), i.e., (4A) or (4B) as described above is carried out. The step (4A) is a step of etching the surface-roughened aluminum plate surface with an alkali solution so that the dissolution amount of the aluminum is from 3 to 5 g/m², and then neutralizing the etched aluminum plate surface with an acid solution. The step (4B) is a step of etching the surface-roughened aluminum plate surface with an acidic solution containing mainly phosphoric acid so that the dissolution amount of the aluminum is from 3 to 5 g/m².

After the step (5) of electrolytically surface-roughening employing alternating current, the step (6) described above is carried out which desmuts smut produced on the aluminum plate surface in step (5) in an acidic solution containing mainly phosphoric acid, so that the residual amount of the smut, which is not dissolved, is from 0.05 to 0.3 g/m².

The first step in the electrolytically surface roughening employing alternating current forms a primary roughened surface to secure water and ink balance which is required in a planographic printing plate, and the second step in the electrolytically surface roughening employing alternating current forms a secondary finely roughened surface to secure adhesion to a light sensitive layer and more hydrophilic surface.

In the electrolytically surface roughening employing alternating current, a process in which a roughened surface is formed during anodic polarity and aluminum is deposited on the surface at cathodic polarity is repeated, the roughened surface is covered with deposit (also referred to as smut).

After the electrolytically surface roughening employing alternating current, treatment such as desmut treatment to remove the produced smut or alkali etching treatment is ordinarily carried out, followed by anodization or hydrophilization treatment. When the desmut treatment or alkali etching treatment is excessively carried out, the roughened surface formed is dissolved out, while when it is insufficient, removal of smut is insufficient, resulting in background contamination during printing.

In the invention, after the first electrolytically surface-roughening step forming a primary roughened surface, the step (4), i.e., (4A) or (4B) as described above is carried out in order to completely remove smut produced during the first electrolytically surface-roughening step. Subsequently, the second electrolytically surface-roughening step forming a secondary roughened surface is carried out and then a step is carried out in which a slight amount of smut produced during the second electrolytically surface-roughening step remains.

In the electrolytically surface roughening employing alternating current in the first step, which is carried out in the electrolytic solution containing mainly hydrochloric acid, the electrolytic solution has a hydrochloric acid concentration of from 5 to 20 g/liter, and preferably from 6.5 to 16 g/liter.

The temperature of the electrolytic solution is in the range of preferably from 15 to 40° C., and more preferably from 18 to 38° C.

The aluminum ion concentration in the electrolytic solution is preferably from 0.5 to 15 g/liter, and more preferably from 0.7 to 10 g/liter.

It is preferred that the electrolytic solution contains acetic acid. The acetic acid concentration in the electrolytic solution is preferably from 0 to 20 g/liter, and more preferably from 3 to 15 g/liter.

The concentration ratio of acetic acid to hydrochloric acid is preferably from 0.5 to 1.5 (by weight concentration).

The current density is in the range of from 35 to 150 A/dm², and preferably from 20 to 90 A/dm². The quantity of electricity is in the range of from 600 to 1500 A·second/dm².

A frequency is in the range of preferably from 40 to 150 Hz.

The first electrolytically surface roughening step may comprise several steps. There are, for example, a method in which current density is stepwise changed, a method in which alternating waveform is stepwise changed, a method in which frequency is stepwise changed, and a method in which the acid concentration of the acidic electrolytic solution is stepwise changed.

After the electrolytically surface roughening, water washing is preferably carried out.

After the first electrolytically surface roughening step, the step (4A) or (4B) above is carried out, in which in the step (4A) the surface roughened aluminum plate is etched with an alkali solution so that the dissolution amount of the aluminum is from 3 to 5 g/m² and then neutralized with an acid solution and in the step (4B) the surface roughened aluminum plate is etched with an acidic solution containing mainly phosphoric acid so that the dissolution amount of the aluminum is from 3 to 5 g/m².

In the invention, the dissolution amount of the aluminum from an aluminum plate refers to dissolution amount of the aluminum from both the roughened surface of the aluminum plate and the unroughened surface of the aluminum plate opposite the roughened surface, including the dissolution amount of smut formed on the aluminum plate surface on electrolytically surface-roughening employing alternating current.

A solution used for the alkali solution etching is preferably an aqueous sodium hydroxide solution.

The sodium hydroxide concentration of the aqueous sodium hydroxide solution is preferably from 0.5 to 6% by weight.

The temperature of the sodium hydroxide solution is not specifically limited, and can be adjusted, taking sodium hydroxide concentration and the etching time, so that the aluminum dissolution amount is that described above.

As the etching method, there is an immersing method or a spraying method employing spray nozzles. The immersing method is preferred. After etching by the alkali solution, water washing is preferably carried out.

After etching by the alkali solution, neutralization is carried out employing an acidic solution.

As the acidic solution, a solution of phosphoric acid, nitric acid, sulfuric acid, chromic acid or a mixture thereof is employed, and a nitric acid solution is preferably employed.

The nitric acid solution has a nitric acid concentration of from 1 to 10% by weight, the temperature thereof is preferably from 15 to 30° C., and neutralization time is from 5 to 30 seconds. As the neutralization method, there is an immersing method or spraying method, and the immersing method is preferred. After neutralization, water washing is preferably carried out.

The acidic solution as described above containing mainly phosphoric acid is a phosphoric acid solution containing phosphoric acid in an amount of from 25 to 450 g/liter, and preferably from 75 to 250 g/liter.

The temperature of the acidic solution in etching step of step (4B) above is not specifically limited, and can be adjusted, taking phosphoric acid concentration and the etching time, so that the aluminum dissolution amount is that described above.

As the etching method, there is an immersing method or spraying method, and the immersing method is preferred. After etching employing an acidic solution containing mainly phosphoric acid, water washing is preferably carried out.

In the second electrolytically surface roughening step employing alternating current, which is carried out in the electrolytic solution containing mainly hydrochloric acid, the electrolytic solution has a hydrochloric acid concentration of from 5 to 20 g/liter, and preferably from 6.5 to 16 g/liter.

The temperature of the electrolytic solution is in the range of preferably from 15 to 40° C., and more preferably from 18 to 38° C.

The aluminum ion concentration of the electrolytic solution is preferably from 0.5 to 15 g/liter, and more preferably from 0.7 to 10 g/liter.

The electrolytic solution contains preferably acetic acid, and the acetic acid concentration of the electrolytic solution is preferably from 1 to 20 g/liter, and more preferably from 3 to 15 g/liter.

The concentration ratio of acetic acid to hydrochloric acid is preferably from 0.5 to 1.5 (by weight concentration).

The current density is preferably from 15 to 30 A/dm², and more preferably from 18 to 27 A/dm².

The quantity of electricity is in the range of from 100 to 400 A·second/dm², and preferably from 130 to 380 A·second/dm².

The frequency is in the range of preferably from 40 to 150 Hz.

The second electrolytically surface roughening step may comprise several steps. There are, for example, a method in which current density is stepwise changed, a method in which alternating waveform is stepwise changed, a method in which frequency is stepwise changed, and a method in which the acid concentration of the acidic electrolytic solution is stepwise changed.

The electrolytic solution used in the second electrolytically surface roughening step may be the same as in the first electrolytically surface roughening step. After the electrolytically surface roughening, water washing is preferably carried out.

After the second electrolytically surface roughening step, the step (6) above is carried out. That is, smut, which is produced on the aluminum plate surface in step (5) above in an acidic solution containing mainly phosphoric acid, is desmutted so that the residual amount of the smut, which is undissolved, is from 0.05 to 0.3 g/m².

The amount of the undissolved smut can be obtained from the difference between weights of aluminum plates desmutted as above before and after the undissolved smut is dissolved in for example, an aqueous phosphoric acid chromic acid solution which is prepared by dissolving 35 ml of a 85% by weight phosphoric acid solution and 20 g of chromium (IV) oxide in 1 liter of water.

The acidic solution containing mainly phosphoric acid in step (6) refers to a solution containing phosphoric acid in an amount of from 25 to 450 g/liter, and preferably from 75 to 250 g/liter.

The acidic solution containing mainly phosphoric acid preferably contains an aluminum ion, and the aluminum ion concentration of the acidic solution is preferably from 0.01 to 10 g/liter, and preferably from 1 to 5 g/liter.

The temperature of this acidic solution is preferably from 30 to 80° C., and more preferably from 35 to 75° C.

Taking a phosphoric acid concentration and temperature of the acid solution into account, the desmut time can be adjusted so that the residual amount of the smut, which is undissolved, is from 0.05 to 0.3 g/m².

When the desmut time is determined, a phosphoric acid concentration and temperature of the acid solution can be adjusted.

In the aluminum support manufacturing method of the invention, anodizing treatment in step (7) above is carried out after the desmut treatment in step (6) above.

There is no restriction in particular for the method of anodizing treatment, and known methods can be used. The anodizing treatment forms an anodization film on the plate surface. Generally, the anodizing treatment is carried out in an electrolytic solution containing sulfuric acid, phosphoric acid or their mixture applying a direct current.

In the invention, the anodizing treatment is carried out preferably in a sulfuric acid solution.

The sulfuric acid concentration of the sulfuric acid solution is preferably from 5 to 50% by weight, and more preferably from 10 to 35% by weight. The temperature of the sulfuric acid solution is preferably from 10 to 50° C. Voltage applied is preferably not less than 18 V, and more preferably not less than 20 V. Current density applied is preferably from 1 to 30 A/dm². Quantity of electricity is preferably from 100 to 500 C/dm².

The coated amount of the formed anodization film is suitably 1 to 50 mg/dm², and preferably 10 to 40 mg/dm². The coated amount of the formed anodization film can be obtained from the difference between weights of the aluminum plates before and after the formed anodization film is dissolved in for example, an aqueous phosphoric acid chromic acid solution which is prepared by dissolving 35 ml of a 85% by weight phosphoric acid solution and 20 g of chromium (IV) oxide in 1 liter of water. Micro pores are formed in the anodization film. The micro pore density in the anodization film is preferably from 400 to 700/μm², and more preferably from 400 to 600/μm².

The aluminum plate, which has been subjected to anodizing treatment, is optionally subjected to sealing treatment. For the sealing treatment, it is possible to use known methods using hot water, boiling water, steam, a sodium silicate solution, an aqueous dichromate solution, a nitrite solution and an ammonium acetate solution.

In the invention, the aluminum plate obtained after the steps as above were carried out is preferably subjected to hydrophilization treatment. There is no restriction in particular for the method of hydrophilization treatment, and there is a method of coating on the plate water soluble resins such as polyvinyl phosphonic acid, a homopolymer or copolymer having in the side chain a sulfonic acid group, polyacrylic acid, water soluble metal salts (for example, zinc borate), yellow dyes or amine salts. Sol-gel treatment substrate as disclosed in Japanese Patent O.P.I. Publication No. 5-304358 is used which forms a covalent bond with a functional group capable of causing addition reaction by radicals. The hydrophilization treatment is preferably carried out employing polyvinyl phosphonic acid. As the treating methods, there are for example, a coating method, a spraying method, or a dipping method, and the invention is not limited thereto. The dipping method is preferred in that the facility is cheap. An aqueous polyvinyl phosphonic acid solution used in the dipping method is preferably an aqueous 0.05 to 3% polyvinyl phosphonic acid solution. The treatment temperature is preferably from 20 to 90° C., and the treatment time is preferably from 10 to 180 seconds. After the hydrophilization treatment, excessive polyvinyl phosphonic acid is preferably removed from the aluminum plate surface through washing or squeegeeing. After that, the resulting aluminum plate is preferably dried at preferably from 90 to 250° C.

It is preferred in printability, particularly supply of dampening water that the aluminum support of the invention for a planographic printing plate material subjected to the treatments of steps (1) through (7) above has a roughened surface with an arithmetic average roughness (Ra) of from 0.40 to 0.60 μM.

The arithmetic average roughness (Ra) in the present invention is specified in ISO 4287.

The arithmetic average roughness Ra (μm) is represented by the following equation,

$$Ra = \frac{1}{L} {\int }_{0}^{L} \vert f ( x ) \vert d x$$

wherein Y=f(X) represents a surface roughness curve when the direction of the center line of the curve is set as the X-axis, and the direction of longitudinal magnification is set as the Y-axis; and L represents measured length L in the center line direction which is extracted from the roughness curve with a cut-off value of 0.8 mm.

As the measuring apparatus to measure arithmetic average roughness (Ra), there is, for example, a contact type surface roughness measuring instrument (SE 1700α produced by Kosaka Laboratory Ltd.).

### (Image Formation Layer)

The planographic printing plate material of the invention has an image formation layer on the roughened surface side of the support as described above for a planographic printing plate material.

The image formation layer in the invention is a layer capable of forming an image by imagewise exposure. As the image formation layer, a positive or negative working image formation layer used in a conventional light sensitive planographic printing plate material can be used.

As the image formation layer in the invention, a thermosensitive image formation layer or a photopolymerizable image formation layer is preferably used.

As the thermosensitive image formation layer, a layer capable of forming an image employing heat generated due to laser exposure is preferred.

As the layer capable of forming an image employing heat generated due to laser exposure, a positive working thermosensitive image formation layer containing a compound capable of being decomposed by an acid or a negative working image formation layer such as a thermosensitive image formation layer containing a polymerizable composition or a thermosensitive image formation layer containing thermoplastic particles are preferably used.

Removal of the image formation layer is preferably carried out on a printing press. That is, the image formation layer is preferably a layer capable of being subjected to on-press development.

Herein a layer capable of being subjected to on-press development refers to one in which after imagewise exposed, the non-image portions are capable of being removed by supplying dampening water and/or printing ink during planographic printing.

As the positive working image formation layer containing a compound capable of being decomposed by an acid, there is, for example, an image formation layer comprising a photolytically acid generating compound capable of generating an acid on laser exposure, an acid decomposable compound, which is decomposed by the generated acid to increase solubility to a developer, and an infrared absorber, as disclosed in Japanese Patent O.P.I. Publication Nos. 9-171254.

As the photolytically acid generating compound there are various conventional compounds and mixtures. For example, a salt of diazonium, phosphonium, sulfonium or iodonium ion with BF₄⁻, PF₆⁻, SbF₆⁻, SiF₆²⁻ or ClO₄⁻, an organic halogen containing compound, o-quinonediazide sulfonylchloride or a mixture of an organic metal and an organic halogen-containing compound is a compound capable of generating or releasing an acid on irradiation of an active light, and can be used as the photolytically acid generating compound in the invention. The organic halogen-containing compound known as an photoinitiator capable of forming a free radical is a compound capable of generating a hydrogen halide and can be used as the photolytically acid generating compound. The examples of the organic halogen containing compound capable of forming a hydrogen halide include those disclosed in U.S. Pat. Nos. 3,515,552, 3,536,489 and 3,779,778 and West German Patent No. 2,243,621, and compounds generating an acid by photodegradation disclosed in West German Patent No. 2,610,842. As the photolytically acid generating compound, o-naphthoquinone diazide-4-sulfonylhalogenides disclosed in Japanese Patent O.P.I. Publication No. 50-30209 can be also used.

As the photolytically acid generating compound, an organic halogen-containing compound is preferred in view of sensitivity to infrared rays and storage stability. The organic halogen-containing compound is preferably a halogenated alkyl-containing triazines or a halogenated alkyl-containing oxadiazoles, and especially preferably a halogenated alkyl-containing s-triazines.

The content of the photolytically acid generating compound in the image formation layer is preferably 0.1 to 20% by weight, and more preferably 0.2 to 10° by weight based on the total weight of the solid components of the image formation layer, although the content broadly varies depending on its chemical properties, or kinds or physical properties of image formation layer used.

As the acid decomposable compound, there are a compound having a C—O—C bond disclosed in Japanese Patent O.P.I. Publication Nos. 48-89003, 51-120714, 53-133429, 55-12995, 55-126236 and 56-17345, a compound having an Si—O—C bond disclosed in Japanese Patent O.P.I. Publication Nos. 60-37549 and 60-121446, another acid decomposable compound disclosed in Japanese Patent O.P.I. Publication Nos. 60-3625 and 60-10247, a compound having an Si—N bond disclosed in Japanese Patent O.P.I. Publication No. 62-222246, a carbonic acid ester disclosed in Japanese Patent O.P.I. Publication No. 62-251743, an orthocarbonic acid ester disclosed in Japanese Patent O.P.I. Publication No. 62-209451, an orthotitanic acid ester disclosed in Japanese Patent O.P.I. Publication No. 62-280841, an orthosilicic acid ester disclosed in Japanese Patent O.P.I. Publication No. 62-280842, an acetal or ketal disclosed in Japanese Patent O.P.I. Publication No. 63-10153 and a compound having a C—S bond disclosed in Japanese Patent O.P.I. Publication No. 62-244038. Of these compounds, the compound having a C—O—C bond, the compound having an Si—O—C bond, the orthocarbonic acid ester, the acetal or ketal or the silylether disclosed in Japanese Patent O.P.I. Publication Nos. 53-133429, 56-17345, 60-121446, 60-37549, 62-209451 and 63-10153 are preferable.

The content of the acid decomposable compound in the image formation layer is preferably 5 to 70% by weight, and more preferably 10 to 50% by weight based on the total weight of the solid components of the image formation layer. The acid decomposable compounds may be used alone or as an admixture of two or more kinds thereof.

The image formation layer in the invention preferably contains a light-to-heat conversion material which is capable of changing exposure light to heat. Examples of the light-to-heat conversion material include a light-to-heat conversion dye and a light-to-heat conversion compound, each described below.

### [Light-to-Heat Conversion Dye]

As light-to-heat conversion dyes, dyes described below can be used.

Examples of the light-to-heat conversion dye include a general infrared absorbing dye such as a cyanine dye, a chloconium dye, a polymethine dye, an azulenium dye, a squalenium dye, a thiopyrylium dye, a naphthoquinone dye or an anthraquinone dye, and an organometallic complex such as a phthalocyanine compound, a naphthalocyanine compound, an azo compound, a thioamide compound, a dithiol compound or an indoaniline compound. Exemplarily, the light-to-heat conversion materials include those disclosed in Japanese Patent O.P.I. Publication Nos. 63-139191, 64-33547, 1-160683, 1-280750, 1-293342, 2-2074, 3-26593, 3-30991, 3-34891, 3-36093, 3-36094, 3-36095, 3-42281, 3-9-7589 and 3-103476. These compounds may be used singly or in combination.

Those described in Japanese Patent O.P.I. Publication Nos. 11-240270, 11-265062, 2000-309174, 2002-49147, 2001-162965, 2002-144750, and 2001-219667 can be preferably used.

### [Other Light-to-Heat Conversion Compound]

In addition to the above light-to-heat conversion dyes, other light-to-heat conversion compounds can be used in combination.

As other light-to-heat conversion compounds, carbon, graphite, a metal and a metal oxide are preferably used.

Furnace black and acetylene black is preferably used as the carbon. The graininess (d₅₀) thereof is preferably not more than 100 nm, and more preferably not more than 50 nm.

The graphite is one having a particle size of preferably not more than 0.5 μm, more preferably not more than 100 nm, and most preferably not more than 50 nm.

As the metal, any metal can be used as long as the metal is in a form of fine particles having preferably a particle size of not more than 0.5 μm, more preferably not more than 100 nm, and most preferably not more than 50 nm. The metal may have any shape such as spherical, flaky and needle-like. Colloidal metal particles such as those of silver or gold are particularly preferred.

As the metal oxide, materials having black color in the visible regions or materials which are electro-conductive or semi-conductive can be used.

Examples of the former include black iron oxide and black complex metal oxides containing at least two metals.

Examples of the latter include Sb-doped SnO₂ (ATO), Sn-added In₂O₃ (ITO), TiO₂, TiO prepared by reducing TiO₂ (titanium oxide nitride, generally titanium black).

Particles prepared by covering a core material such as BaSO₄, TiO₂, 9Al₂O₃.2B₂O and K₂O.nTiO₂ with these metal oxides are usable.

These oxides are particles having a particle size of not more than 0.5 μm, preferably not more than 100 nm, and more preferably not more than 50 nm.

As these light-to-heat conversion compounds, black iron oxide or black complex metal oxides containing at least two metals are more preferred.

Examples of the black complex metal oxides include complex metal oxides comprising at least two selected from Al, Ti, Cr, Mn, Fe, Co, Ni, Cu, Zn, Sb, and Ba. These can be prepared according to the methods disclosed in Japanese Patent O.P.I. Publication Nos. 9-27393, 9-25126, 9-237570, 9-241529 and 10-231441.

The complex metal oxide is preferably a complex Cu—Cr—Mn type metal oxide or a Cu—Fe—Mn type metal oxide. The Cu—Cr—Mn type metal oxides are preferably subjected to the treatment disclosed in Japanese Patent O.P.I. Publication Nos. 8-27393 in order to reduce isolation of a 6-valent chromium ion. These complex metal oxides have a high color density and a high light heat conversion efficiency.

The primary average particle size of these complex metal oxides is preferably from 0.001 to 1.0 μm, and more preferably from 0.01 to 0.5 μm. The primary average particle size of from 0.001 to 1.0 μm improves a light heat conversion efficiency relative to the addition amount of the particles, and the primary average particle size of from 0.05 to 0.5 μm further improves a light heat conversion efficiency relative to the addition amount of the particles.

The light heat conversion efficiency relative to the addition amount of the particles depends on a dispersity of the particles, and the well-dispersed particles have a high light heat conversion efficiency.

Accordingly, these complex metal oxide particles are preferably dispersed according to a known dispersing method, separately to a dispersion liquid (paste), before being added to a coating liquid for the particle containing layer. The metal oxides having a primary average particle size of less than 0.001 are not preferred since they are difficult to disperse. A dispersant is optionally used for dispersion. The addition amount of the dispersant is preferably from 0.01 to 5% by weight, and more preferably from 0.1 to 2% by weight, based on the weight of the complex metal oxide particles.

The image formation layer optionally contains a binder.

As a positive working image formation layer, an image formation layer containing o-naphthoquinone is preferably used.

The light-to-heat conversion material described above may be contained in the image formation layer or in a layer adjacent thereto.

As the thermosensitive image formation layer containing a polymerizable composition described above, there is a thermosensitive image formation layer containing a light-to-heat conversion material (a) having an absorption band in a wavelength region of from 700 to 1300 nm, a polymerization initiator (b) and a polymerizable unsaturated compound (c). (Light-to-heat conversion material (a) having an absorption band in a wavelength region of from 700 to 1300 nm)

As the light-to-heat conversion material (a) having an absorption band in a wavelength region of from 700 to 1300 nm, There are the infrared absorbing dyes described above. Preferred are dyes such as cyanine dyes, squalirium dyes, oxonol dyes, pyrylium dyes, thiopyrylium dyes, polymethine dyes, oil soluble phthalocyanine dyes, triarylamine dyes, thiazolium dyes, oxazolium dyes, polyaniline dyes, polypyrrole dyes and polythiophene dyes.

Besides the above, pigments such as carbon black, titanium black, iron oxide powder, and colloidal silver can be preferably used. Cyanine dyes as dyes, and carbon black as pigments are especially preferred, in view of extinction coefficient, light-to-heat conversion efficiency and cost.

The content of the light-to-heat conversion material (a) in the thermosensitive image formation layer containing a polymerizable composition is preferably from 0.5 to 15% by weight and more preferably from 1 to 5% by weight. Further, the content of the light-to-heat conversion material in the image formation layer is different due to extinction coefficient of the light-to-heat conversion material, but is preferably an amount giving a reflection density of from 0.3 to 3.0, and preferably from 0.5 to 2.0. For example, in order to obtain the above reflection density, the content of the cyanine dye in the image formation layer is 10 to 100 mg/m².

This light-to-heat conversion material also may be contained in the image formation layer or in a layer adjacent thereto.

### Polymerization Initiator (b)

The photopolymerization initiator is a compound capable of initiating polymerization of an unsaturated monomer by laser. Examples thereof include carbonyl compounds, organic sulfur compounds, peroxides, redox compounds, azo or diazo compounds, halides and photo-reducing dyes disclosed in J. Kosar, “Light Sensitive Systems”, Paragraph 5, and those disclosed in British Patent No. 1,459,563.

Typical examples of the photopolymerization initiator include the following compounds:

A benzoin derivative such as benzoin methyl ether, benzoin i-propyl ether, or α,α-dimethoxy-α-phenylacetophenone; a benzophenone derivative such as benzophenone, 2,4-dichlorobenzophenone, o-benzoyl methyl benzoate, or 4,4′-bis(dimethylamino)benzophenone; a thioxanthone derivative such as 2-chlorothioxanthone, 2-i-propylthioxanthone; an anthraquinone derivative such as 2-chloroanthraquinone or 2-methylanthraquinone; an acridone derivative such as N-methylacridone or N-butylacridone; α,α-diethoxyacetophenone; benzil; fluorenone; xanthone; an uranyl compound; a triazine derivative disclosed in Japanese Patent Publication Nos. 59-1281 and 61-9621 and Japanese Patent O.P.I. Publication No. 60-60104; an organic peroxide compound disclosed in Japanese Patent O.P.I. Publication Nos. 59-1504 and 61-243807; a diazonium compound in Japanese Patent Publication Nos. 43-23684, 44-6413, 47-1604 and U.S. Pat. No. 3,567,453; an organic azide compound disclosed in U.S. Pat. Nos. 2,848,328, 2,852,379 and 2,940,853; orthoquinondiazide compounds disclosed in Japanese Patent Publication Nos. 36-22062b, 37-13109, 38-18015 and 45-9610; various onium compounds disclosed in Japanese Patent Publication No. 55-39162, Japanese Patent O.P.I. Publication No. 59-14023 and “Macromolecules”, Volume 10, p. 1307 (1977); azo compounds disclosed in Japanese Patent Publication No. 59-142205; metal arene complexes disclosed in Japanese Patent O.P.I. Publication No. 1-54440, European Patent Nos. 109,851 and 126,712, and “Journal of Imaging Science”, Volume 30, p. 174 (1986); (oxo) sulfonium organoboron complexes disclosed in Japanese Patent O.P.I. Publication Nos. 5-213861 and 5-255347; titanocenes disclosed in Japanese Patent O.P.I. Publication Nos. 59-152396 and 61-151197; transition metal complexes containing a transition metal such as ruthenium disclosed in “Coordination Chemistry Review”, Volume 84, p. 85-277 (1988) and Japanese Patent O.P.I. Publication No. 2-182701; 2,4,5-triarylimidazole dimmer disclosed in Japanese Patent O.P.I. Publication No. 3-209477; carbon tetrabromide; organic halide compounds disclosed in Japanese Patent O.P.I. Publication No. 59-107344.

Furthermore, the following are cited as an example of a polymerization initiator.

Compounds which can generate a radical disclosed in JP-A 2002-537419; polymerization initiators disclosed in Japanese Patent O.P.I. Publication Nos. 2001-175006, 2002-278057, and 2003-5363; onium salts which have two or more cation sections in the molecule disclosed in Japanese Patent O.P.I. Publication No. 2003-76010, N-nitrosamine compounds disclosed in Japanese Patent O.P.I. Publication No. 2001-133966; compounds which generate a radical with heat disclosed in Japanese Patent O.P.I. Publication No. 2001-343742, compounds which generate an acid or a radical with heat disclosed in JP-A No. 2002-6482; berates described in JP-A No. 2002-116539; compounds which generate an acid or a radical with heat disclosed in Japanese Patent O.P.I. Publication No. 2002-148790; photolytic or thermal polymerization initiators which have an unsaturated group of the polymerizable disclosed in Japanese Patent O.P.I. Publication No. 2002-207293; onium salts which have an anion of divalence or more as a counter ion disclosed in Japanese Patent O.P.I. Publication No. 2002-268217; sulfonyl sulfone compounds having a specified structure disclosed in Japanese Patent O.P.I. Publication No. 2002-328465; and compounds which generate a radical with heat disclosed in Japanese Patent O.P.I. Publication No. 2002-341519.

Especially preferable compounds are an onium salt and a poly halogenated compound.

The following are cited as the onium salt.

Diazonium salts disclosed in S. I. Schlesinger, Photogr. Sci. Eng., 18, 387 (1974), T. S. Bal et al., Polymer, 21, 423 (1980); ammonium salts disclosed in U.S. Pat. Nos. 4,069,055, 4,069,056, 4,027,992; phosphonium salts disclosed in D. C. Necker et al., Macromolecules, 17, 2468 (1984), C. S. Wen et al., The, Proc. Conf. Rad. Curing ASIA, p 478, Tokyo, October (1988), U.S. Pat. Nos. 4,069,055 and 4,069,056; iodonium salts disclosed in J. V. Crivello et al., Macromorecules, 10 (6), 1307 (1977), Chem. & amp, Eng. News, Nov. 28, p 31 (1988), E. P. No. 104,143, and U.S. Pat. Nos. 339,049, 410,201, Japanese Patent O.P.I. Publication Nos. 2-150848 and 2-296514; sulfonium salts disclosed in J. V. Crivello et al., Polymer J. 17, 73 (1985), J. V. Crivello et al., J. Org. Chem., 43, 3055 (1978), W. R. Watt et al., J. Polymer Sci., Polymer Chem. Ed., 22, 1789 (1984) J. V. Crivello et al., Polymer Bull., 14, 279 (1985) J. V. Crivello et al., Macromorecules, 14(5), 1141 (1981) J. V. Crivello et al., J. Polymer Sci., Polymer Chem. Ed., 17, 2877 (1979), EP Nos. 370,693, 3,902,114, 233,567, 297,443, 297,442, U.S. Pat. Nos. 4,933,377, 161,811, 410,201, 339,049, 4,760,013, 4,734,444, 2,833,827, DP Nos. 2,904,626, 3,604,580, and 3,604,581; selenonium salts disclosed in J. V. Crivello et al., Macromorecules, 10 (6), 1307 (1977), J. V. Crivello et al., J. Polymer Sci., and Polymer Chem. Ed., 17, 1047 (1979); and ammonium salts disclosed in C. S. Wen et al., The, Proc. Conf. Rad. Curing ASIA, p. 478 Tokyo, October (1988).

Among the above onium salts, iodonium salts and sulfonium salts are especially preferred.

The preferred examples of the sulfonium salts are as follows:

Triphenylsulfonium tetrafluoroborate, methyldiphenyl sulfonium tetrafluoroborate, dimethylphenylsulfonium hexafluorophosphate, 4-butoxyphenyldiphenylsulfonium tetrafluoroborate, 4-chloropheryldiphenylsulfonium hexafluorophosphate, tri(4-phenoxylphenyl)sulfonium hexafluorophosphate, di(4-ethoxyphenyl)methylsulfonium hexafluoroarsenate, 4-acetonyl phenyldiphenylsulfonium tetrafluoroborate, 4-thiomehoxyphenyl diphenylsulfonium hexafluorophosphate, di(methoxysulfonylphenyl)methylsulfonium hexafluoroantimonate, di(nitrophenyl)phenylsulfonium hexafluoroantimonate, di(carbomethoxyphenyl)methylsulfonium hexafluorophosphate, 4-acetamidophenyldiphenylsulfonium tetrafluoroborate, dimethylnaphthylsulfonium hexafluorophosphate, trifluoromethyldiphenylsulfonium tetrafluoroborate, p-(phenyl thiophenyl)diphenylsulfonium hexafluoroantimonate, 10-methyl phenoxathiinium hexafluorophosphate, 5-methylthianthrenium hexafluorophosphate, 10-phenyl-9,9-dimethylthioxanthenium hexafluorophosphate, triphenylsulfonium tetrakis (pentafluorophenyl)borate.

The preferred examples of the iodonium salts are as follows:

Diphenyliodonium iodide, diphenyliodonium hexafluoroantimonate, 4-chlorophenyliodonium tetrafluoroborate, di(4-chlorophenyl)iodonium hexafluoroantimonate, diphenyliodonium hexafluorophosphate, diphenyliodonium trifluoroacetate, 4-trifluoromethylphenyl iodonium tetrafluoroborate, diphenyliodonium hexafluoroarsenate, ditolyliodonium hexafluorophosphate, di(4-methoxyphenyl)iodonium hexafluoroantimonate, di(4-methoxy phenyl)iodonium chloride, phenyl(4-methylphenyl) iodonium tetrafluoroborate, di(2,4-dimethyl phenyl) iodonium hexafluoroantimonate, di(4-t-butylphenyl)iodonium hexafluoroantimonate, 2,2′-diphenyliodonium hexafluorophosphate, tolylcumyl diphenyliodonium tetrakis(pentafluorophenyl)borate.

A polyhalogenated compound is a compound containing a trihalogenomethyl group, dihalogenomethyl group or a dihalogenomethylene group in the molecule. Preferable examples are halogenated compounds represented by the following Formula (1) and an oxadiazole compound with the above-described halogenated groups. Among these, a polyhaloacetyl compound represented by formula (2) is especially preferred.

R¹—CY₂—(C═O)—R² Formula (1)

wherein R¹ represents a hydrogen atom, a halogen atom, an alkyl group, an aryl group, an acyl group, an alkylsulfonyl group, an arylsulfonyl group, an iminosulfonyl group or a cyano group; R² represents a monovalent substituent, provided that R¹ and R² may combine with each other to form a ring; and Y represents a halogen atom.

CY₃—(C═O)—X—R³ Formula (2)

wherein R³ represents a monovalent substituent; X represents —O— or —NR⁴—, in which R⁴ represents a hydrogen atom or an alkyl group, provided that R³ and R⁴ may combine with each other to form a ring; and Y represents a halogen atom. Among these, a compound having a polyhalogenated acetylamido group is preferably used.

A compound having an oxadiazole ring with a polyhalogenated methyl group is also preferably used.

The content of the polymerization initiator in the thermosensitive image formation layer is not specifically limited, but is preferably from 0.1 to 20% by weight, and more preferably from 0.8 to 15% by weight.

### (Polymerizable Unsaturated Compound (c))

The image formation layer in the invention can contain a polymerizable unsaturated compound.

The polymerizable unsaturated compound is a compound having a polymerizable unsaturated group. Examples thereof include conventional radically polymerizable monomers, and polyfunctional monomers and polyfunctional oligomers each having plural ethylenically unsaturated bond ordinarily used in UV-curable resins.

The polymerizable unsaturated compound is not specifically limited, but preferred examples thereof include a monofunctional acrylate such as 2-ethylhexyl acrylate, 2-hydroxypropyl acrylate, glycerol acrylate, tetrahydrofurfuryl acrylate, phenoxyethyl acrylate, nonylphenoxyethyl acrylate, tetrahydrofurfuryloxyethyl acrylate, tetrahydrofurfuryloxy-hexyl acrylate, or 1,3-dioxolanyl acrylate; a methacrylate, itaconate, crotonate or maleate alternative of the above acrylate; a bifunctional acrylate such as ethyleneglycol diacrylate, triethyleneglycol diacrylate, pentaerythritol diacrylate, hydroquinone diacrylate, resorcin diacrylate, hexanediol diacrylate, neopentyl glycol diacrylate, tripropylene glycol diacrylate, hydroxypivalic acid neopentyl glycol diacrylate, neopentyl glycol adipate diacrylate, diacrylate of hydroxypivalic acid neopentyl glycol-ε-caprolactone adduct, 2-(2-hydroxy-1,1-dimethylethyl)-5-hydroxymethyl-5-ethyl-1,3-dioxane diacrylate, tricyclodecanedimtethylol acrylate, tricyclodecanedimethylol acrylate-ε-caprolactone adduct or 1,6-hexanediol diglycidylether diacrylate; a dimethacrylate, diitaconate, dicrotonate or dimaleate alternative of the above diacrylate; a polyfunctional acrylate such as trimethylolpropane triacrylate, ditrimethylolpropane tetraacrylate, trimethylolethane triacrylate, pentaerythritol triacrylate, pentaerythritol tetraacrylate, dipentaerythritol tetraacrylate, dipentaerythritol pentaacrylate, dipentaerythritol hexacrylate, dipentaerythritol hexacrylate-ε-caprolactone adduct, pyrrogallol triacrylate, propionic acid dipentaerythritol triacrylate, propionic acid dipentaerythritol tetraacrylate, hydroxypivalylaldehyde modified dimethylolpropane triacrylate or EO-modified products thereof; and a methacrylate, itaconate, crotonate or maleate alternative of the above polyfunctional acrylate.

A prepolymer can be used as described above, and the prepolymer can be used singly, as an admixture of the above described monomers and/or oligomers.

Examples of the prepolymer include polyester (meth)acrylate obtained by incorporating (meth)acrylic acid in a polyester of a polybasic acid such as adipic acid, trimellitic acid, maleic acid, phthalic acid, terephthalic acid, hymic acid, malonic acid, succinic acid, glutaric acid, itaconic acid, pyromellitic acid, fumalic acid, pimelic acid, sebatic acid, dodecanic acid or tetrahydrophthalic acid with a polyol such as ethylene glycol, ethylene glycol, diethylene glycol, propylene oxide, 1,4-butane diol, triethylene glycol, tetraethylene glycol, polyethylene glycol, glycerin, trimethylol propane, pentaerythritol, sorbitol, 1,6-hexanediol or 1,2,6-hexanetriol; an epoxyacrylate such as bisphenol A.epichlorhydrin.(meth)acrylic acid or phenol novolak.epichlorhydrin.(meth)acrylic acid obtained by incorporating (meth)acrylic acid in an epoxy resin; an urethaneacrylate such as ethylene glycol.adipic acid.tolylenediisocyanate.2-hydroxyethylacrylate, polyethylene glycol.tolylenediisocyanate.2-hydroxyethylacrylate, hydroxyethylphthalyl methacrylate.xylenediisocyanate, 1,2-polybutadieneglycol.tolylenediisocyanate.2-hydroxyethylacrylate or trimethylolpropane propylene glycol.tolylenediisocyanate.2-hydroxyethylacrylate, obtained by incorporating (meth)acrylic acid in an urethane resin; a silicone acrylate such as polysiloxane acrylate, or polysiloxane.diisocyanate.2-hydroxyethylacrylate; an alkyd modified acrylate obtained by incorporating a methacroyl group in an oil modified alkyd resin; and a spiran resin acrylate.

The image formation layer can contain a monomer such as a phosphazene monomer, triethylene glycol, an EO modified isocyanuric acid diacrylate, an EO modified isocyanuric acid triacrylate, dimethyloltricyclodecane diacrylate, trimethylolpropane acrylate benzoate, an alkylene glycol acrylate, or a urethane modified acrylate, or an addition polymerizable oligomer or prepolymer having a structural unit derived from the above monomer.

As a monomer used in combination in the image formation layer, there is a phosphate compound having at least one (meth)acryloyl group. The phosphate compound is a compound having a (meth)acryloyl group in which at least one hydroxyl group of phosphoric acid is esterified.

Besides the above compounds, compounds disclosed in Japanese Patent O.P.I. Publication Nos. 58-212994, 61-6649, 62-46688, 62-48589, 62-173295, 62-187092, 63-67189, and 1-244891, compounds described on pages 286 to 294 of “11290 Chemical Compounds” edited by Kagakukogyo Nipposha, and compounds described on pages 11 to 65 of “UV.EB Koka Handbook (Materials)” edited by Kobunshi Kankokai can be suitably used. Of these compounds, compounds having two or more acryl or methacryl groups in the molecule are preferable, and those having a molecular weight of not more than 10,000, and preferably not more than 5,000 are more preferable.

In the invention, a polymerizable unsaturated compound having a tertiary amino group in the molecule can be used preferably. The monomer is not specifically limited to the chemical structure, but is preferably a hydroxyl group-containing tertiary amine Modified with glycidyl methacrylate, methacrylic acid chloride or acrylic acid chloride. Typically, a polymerizable compound is preferably used which is disclosed in Japanese Patent O.P.I. Publication Nos. 1-203413 and 1-197213.

In the invention, a reaction product of a tertiary amine having two or more hydroxyl groups in the molecule, a diisocyanate and a compound having a hydroxyl group and an addition polymerizable ethylenically double bond in the molecule is preferably used. A compound having a tertiary amino group and an amide bond in the molecule is especially preferred.

The tertiary amine having two or more hydroxyl groups in the molecule has a hydroxyl group of preferably from 2 to 6, and more preferably from 2 to 4. Examples of the tertiary amine having two or more hydroxyl groups in the molecule include triethanolamine, N-methyldiethanolamine, N-ethyldiethanolamine, N-ethyldiethanolamine, N-n-butyldiethanolamine, N-tert-butyldiethanolamine, N,N-di(hydroxyethyl)aniline, N,N,N′,N′-tetra-2-hydroxypropylethylenediamine, p-tolyldiethanolamine, N,N,N′, N′-tetra-2-hydroxyethylethylenediamine, N,N-bis(2-hydroxypropyl)aniline, allyldiethanolamine, 3-dimethylamino-1,2-propane diol, 3-diethylamino-1,2-propane diol, N,N-di(n-propylamino)-2,3-propane diol, N,N-di(iso-propylamino)-2,3-propane diol, and 3-(N-methyl-N-benzylamino)-1,2-propane diol, but the invention is not specifically limited thereto.

Examples of the diisocyanate include butane-1,4-diisocyanate, hexane-1,6-diisocyanate, 2-methylpentane-1,5-diisocyanate, octane-1,8-diisocyanate, 1,3-diisocyanatomethylcyclohexanone, 2,2,4-trimethylhexane-1,6-diisocyanate, isophorone diisocyanate, 1,2-phenylene diisocyanate, 1,3-phenylene diisocyanate, 1,4-phenylene diisocyanate, tolylene-2,4-diisocyanate, tolylene-2,5-diisocyanate, tolylene-2,6-diisocyanate, 1,3-di(isocyanatomethyl)benzene, and 1,3-bis(1-isocyanato-1-methylethyl)benzene, but the invention is not specifically limited thereto.

Examples of the compound having a hydroxyl group and an addition polymerizable ethylenically double bond in the molecule is not specifically limited, but 2-hydroxyethyl methacrylate, 2-hydroxyethyl acrylate, 4-hydroxybutyl acrylate, 2-hydroxypropylene-1,3-dimethacrylate, and 2-hydroxypropylene-1-methacrylate-3-acrylate are preferred.

The reaction product can be synthesized according to the same method as a conventional method in which a urethaneacrylate compound is ordinarily synthesized employing a diol, a diisocyanate and an acrylate having a hydroxyl group.

Examples of the reaction product of a tertiary amine having two or more hydroxyl groups in the molecule, a diisocyanate having an aromatic ring in the molecule and a compound having a hydroxyl group and an addition polymerizable ethylenically double bond in the molecule will be listed below.

M-1: A reaction product of triethanolamine (1 mmole), hexane-1,6-diisocyanate (3 moles), and 2-hydroxyethyl methacrylate (3 moles)
M-2: A reaction product of triethanolamine (1 mole), isophorone diisocyanate (3 moles), and 2-hydroxyethyl methacrylate (3 moles)
M-3: A reaction product of N-n-butyldiethanolamine (1 mole), 1,3-bis(1-cyanato-1-methylethyl)benzene (2 moles), and 2-hydroxypropylene-1-methacrylate-3-acrylate (2 moles)
M-4: A reaction product of N-n-butyldiethanolamine (1 mole), 1,3-di(cyanatomethyl)benzene (2 moles), and 2-hydroxypropylene-1-methacrylate-3-acrylate (2 moles)
M-5: A reaction product of N-methydiethanolamine (1 mole), tolylene-2,4-diisocyanate (2 moles), and 2-hydroxypropylene-1,3-dimethacrylate (2 moles)
M-6: A reaction product of triethanolamine (1 mole), 1,3-bis(1-isocyanato-1-methylethyl)benzene (3 moles), and 2-hydroxyethyl methacrylate (3 moles)
M-7: A reaction product of ethylenediamine tetraethanol (1 mole), 1,3-bis(1-isocyanato-1-methylethyl)benzene (4 moles), and 2-hydroxyethyl methacrylate (4 moles)

In addition to the above, acrylates or methacrylates disclosed in Japanese Patent O.P.I. Publication Nos. 2-105238 and 1-127404 can be used.

The polymerizable unsaturated compound content of the image formation layer is preferably from 5 to 80% by weight, and more preferably from 15 to 60% by weight.

The thermosensitive image formation layer in the invention comprising the polymerizable composition described above preferably contains an alkali soluble polymer.

The alkali soluble polymer is a polymer having a specific acid value, and as typical examples thereof, the following copolymer having various structure can be suitably used.

Examples of the copolymer include a polyacrylate resin, a polyvinylbutyral resin, a polyurethane resin, a polyamide resin, a polyester resin, an epoxy resin, a phenol resin, a polycarbonate resin, a polyvinyl butyral resin, a polyvinyl formal resin, a shellac resin, or another natural resin. These can be used as an admixture of two or more thereof.

For example, a polymer having a hydroxyl group or a carboxyl group is preferably used, and a polymer having a carboxyl group is more preferably used.

Among these is preferably a vinyl copolymer obtained by copolymerization of an acryl monomer, and more preferably a copolymer containing (a) a carboxyl group-containing monomer unit and (b) an alkyl methacrylate or alkyl acrylate unit as the copolymerization component.

Examples of the carboxyl group-containing monomer include an α,β-unsaturated carboxylic acid, for example, acrylic acid, methacrylic acid, maleic acid, maleic anhydride, itaconic acid, itaconic anhydride or a carboxylic acid such as a half ester of phthalic acid with 2-hydroxymethacrylic acid.

Examples of the alkyl methacrylate or alkyl acrylate include an unsubstituted alkyl ester such as methylmethacrylate, ethylmethacrylate, propylmethacrylate, butylmethacrylate, amylmethacrylate, hexylmethacrylate, heptylmethacrylate, octylmethacrylate, nonylmethacrylate, decylmethacrylate, undecylmethacrylate, dodecylmethacrylate, methylacrylate, ethylacrylate, propylacrylate, butylacrylate, amylacrylate, hexylacrylate, heptylacrylate, octylacrylate, nonylacrylate, decylacrylate, undecylacrylate, or dodecylacrylate; a cyclic alkyl ester such as cyclohexyl methacrylate or cyclohexyl acrylate; and a substituted alkyl ester such as benzyl methacrylate, 2-chloroethyl methacrylate, N,N-dimethylaminoethyl methacrylate, glycidyl methacrylate, benzyl acrylate, 2-chloroethyl acrylate, N,N-dimethylaminoethyl acrylate or glycidyl acrylate.

The polymer binder in the invention can further contain, as another monomer unit, a monomer unit derived from the monomer described in the following items (1) through (14):

(1) A monomer having an aromatic hydroxy group, for example, o-, (p- or m-) hydroxystyrene, or o-, (p- or m-) hydroxyphenylacrylate;

(2) A monomer having an aliphatic hydroxy group, for example, 2-hydroxyethyl acrylate, 2-hydroxyethyl methacrylate, N-methylolacrylamide, N-methylolmethacrylamide, 4-hydroxybutyl acrylate, 4-hydroxybutyl methacrylate, 5-hydroxypentyl acrylate, 5-hydroxypentyl methacrylate, 6-hydroxyhexyl acrylate, 6-hydroxyhexyl methacrylate, N-(2-hydroxyethyl)acrylamide, N-(2-hydroxyethyl)methacrylamide, or hydroxyethyl vinyl ether;

(3) A monomer having an aminosulfonyl group, for example, m- or p-aminosulfonylphenyl methacrylate, m- or p-aminosulfonylphenyl acrylate, N-(p-aminosulfonylphenyl)methacrylamide, or N-(p-aminosulfonylphenyl)acrylamide;

(4) A monomer having a sulfonamido group, for example, N-(p-toluenesulfonyl)acrylamide, or N-(p-toluenesulfonyl)-methacrylamide;

(5) An acrylamide or methacrylamide, for example, acrylamide, methacrylamide, N-ethylacrylamide, N-hexylacrylamide, N-cyclohexylacrylamide, N-phenylacrylamide, N-nitrophenylacrylamide, N-ethyl-N-phenylacrylamide, N-4-hydroxyphenylacrylamide, or N-4-hydroxyphenylmethacrylamide;

(6) A monomer having a fluorinated alkyl group, for example, trifluoromethyl acrylate, trifluoromethyl methacrylate, tetrafluoropropyl methacrylate, hexafluoropropyl methacrylate, octafluoropentyl acrylate, octafluoropentyl methacrylate, heptadecafluorodecyl methacrylate, heptadecafluorodecyl methacrylate, or N-butyl-N-(2-acryloxyethyl)heptadecafluorooctylsulfonamide;

(7) A vinyl ether, for example, ethyl vinyl ether, 2-chloroethyl vinyl ether, propyl vinyl ether, butyl vinyl ether, octyl vinyl ether, or phenyl vinyl ether;

(8) A vinyl ester, for example, vinyl acetate, vinyl chroloacetate, vinyl butyrate, or vinyl benzoate;

(9) A styrene, for example, styrene, methylstyrene, or chloromethystyrene;

(10) A vinyl ketone, for example, methyl vinyl ketone, ethyl vinyl ketone, propyl vinyl ketone, or phenyl vinyl ketone;

(11) An olefin, for example, ethylene, propylene, isobutylene, butadiene, or isoprene;

(12) N-vinylpyrrolidone, N-vinylcarbazole, or N-vinylpyridine,

(13) A monomer having a cyano group, for example, acrylonitrile, methacrylonitrile, 2-pentenenitrile, 2-methyl-3-butene nitrile, 2-cyanoethyl acrylate, or o-, m- or p-cyanostyrene;

(14) A monomer having an amino group, for example, N,N-diethylaminoethyl methacrylate, N,N-dimethylaminoethyl acrylate, N,N-dimethylaminoethyl methacrylate, polybutadiene urethane acrylate, N,N-dimethylaminopropyl acrylamide, N,N-dimethylacrylamide, acryloylmorpholine, N-isopropylacrylamide, or N,N-diethylacrylamide.

Further another monomer may be copolymerized with the above monomer.

An unsaturated bond-containing copolymer, which is obtained by reacting the polymer having a carboxyl group with for example, a compound having a (meth)acryloyl group and an epoxy group, is also preferred.

Examples of the compound having a (meth)acryloyl group and an epoxy group in the molecule include glycidyl acrylate, glycidyl methacrylate and an epoxy group-containing unsaturated compound disclosed in Japanese Patent O.P.I. Publication No. 11-27196.

Of the above alkali soluble polymers, those having an acid value of from 30 to 200 are preferred, and those having an acid value of from 50 to 150 are more preferred. Of these, those having a weight average molecular weight of from 15,000 to 500,000 are preferred, and those having a weight average molecular weight of from 20,000 to 100,000 are more preferred.

Of the above polymers, those having a polymerizable unsaturated group are preferred, and those having 5 to 50% of the polymerizable unsaturated group as a repeating unit are especially preferred.

An alkali soluble polymer having a polymerizable unsaturated group can be synthesized according to a conventional method without any limitations.

For example, a method can be used which reacts a carboxyl group with a glycidyl group, or reacts a hydroxyl group with an isocyanate group.

Typically, the alkali soluble polymer is a reaction product obtained by reacting a copolymer having a carboxyl group-containing monomer unit with an aliphatic epoxy-containing unsaturated compound such as allyl glycidyl ether, glycidyl (meth)acrylate, α-ethylglycidyl (meth)acrylate, glycidyl crotonate, glycidyl isocrotonate, crotonyl glycidyl ether, itaconic acid monoalkylmonoglycidyl ester, fumaric acid monoalkylmonoglycidyl ester, or maleic acid monoalkylmonoglycidyl ester; or an alicyclic epoxy-containing unsaturated compound such as 3,4-epoxycyclohexylmethyl (meth)acrylate. In the invention, when an amount of the carboxyl group reacted with the epoxy-containing unsaturated compound is represented in terms of mol %, The amount is preferably from 5 to 50 mol %, and more preferably from 10 to 30 mol % in view of sensitivity and printing durability.

Reaction of a copolymer having a carboxyl group-containing monomer unit with a compound having an epoxy group and an unsaturated group is carried out for example, at 80 to 120° C. for 1 to 50 hours. The reaction product can be synthesized according to a conventional polymerization method, for example, a method described in literatures such as W. R. Sorenson & T. W. Cambell “Kobunshi Gosei Jikkenho” published by TOKYO KAGAKU DOHJIN, or Japanese Patent O.P.I. Publication Nos. 10-315598 and 11-271963, or a method similar to the above.

The content of the alkali soluble polymer in the image formation layer is preferably from 10 to 90% by weight, more preferably from 15 to 70% by weight, and still more preferably from 20 to 50% by weight.

Examples of the copolymer having a carboxyl group-containing monomer unit described above include a copolymer having at least one selected from units derived from the following monomers (1) through (17).

(1) A monomer having an aromatic hydroxy group;
(2) A monomer having an aliphatic hydroxy group;
(3) A monomer having an aminosulfonyl group;
(4) A monomer having a sulfonamide group;
(5) An α,β-unsaturated carboxylic acid;
(6) A substituted or unsubstituted alkyl acrylate;
(7) A substituted or unsubstituted alkyl acrylate;
(8) Acrylamide or methacrylamide;
(9) A monomer having a fluorinated alkyl group;
(10) A vinyl ether;
(11) A vinyl ester;
(12) A styrene,
(13) A vinyl ketone;
(14) An olefin;

### (15) N-vinylpyrrolidone, N-vinylcarbazole, or N-vinylpyridine;

(16) A monomer having a cyano group; and
(17) A monomer having an amino group.

Typical examples thereof include a monofunctional acrylate such as 2-ethylhexyl acrylate, 2-hydroxypropyl acrylate, glycerol acrylate, tetrahydrofurfuryl acrylate, phenoxyethyl acrylate, nonylphenoxyethyl acrylate, tetrahydrofurfuryloxyethyl acrylate, tetrahydrofurfuryloxyhexyl acrylate, or 1,3-dioxolanyl acrylate; a methacrylate, itaconate, crotonate or maleate alternative of the above acrylate; a bifunctional acrylate such as ethyleneglycol diacrylate, triethyleneglycol diacrylate, pentaerythritol diacrylate, hydroquinone diacrylate, resorcin diacrylate, hexanediol diacrylate, neopentyl glycol diacrylate, tripropylene glycol diacrylate, hydroxypivalic acid neopentyl glycol diacrylate, neopentyl glycol adipate diacrylate, diacrylate of hydroxypivalic acid neopentyl glycol-ε-caprolactone adduct, 2-(2-hydroxy-1,1-dimethylethyl)-5-hydroxymethyl-5-ethyl-1,3-dioxane diacrylate, tricyclodecanedimethylol acrylate, tricyclodecanedimethylol acrylate-ε-caprolactone adduct or 1,6-hexanediol diglycidylether diacrylate; a dimethacrylate, diitaconate, dicrotonate or dimaleate alternative of the above diacrylate; a polyfunctional acrylate such as trimethylolpropane triacrylate, ditrimethylolpropane tetraacrylate, trimethylolethane triacrylate, pentaerythritol triacrylate, pentaerythritol tetraacrylate, dipentaerythritol tetraacrylate, dipentaerythritol pentaacrylate, dipentaerythritol hexacrylate, dipentaerythritol hexacrylate-ε-caprolactone adduct, pyrrogallol triacrylate, propionic acid dipentaerythritol triacrylate, propionic acid dipentaerythritol tetraacrylate or hydroxypivalylaldehyde modified dimethylolpropane triacrylate; a methacrylate, itaconate, crotonate or maleate alternative of the above polyfunctional acrylate.

### (Polymeric Binder)

The image formation layer in the invention can contain a polymeric binder.

Examples of the polymeric binder include a polyacrylate resin, a polyvinylbutyral resin, a polyurethane resin, a polyamide resin, a polyester resin, an epoxy resin, a phenol resin, a polycarbonate resin, a polyvinyl butyral resin, a polyvinyl formal resin, a shellac resin, or another natural resin. These polymeric binders can be used as an admixture of two or more thereof.

### (Polymerization Inhibitor)

The thermosensitive image formation layer can optionally a polymerization inhibitor.

As the polymerization inhibitor, there is for example, a hindered amine with a base dissociation constant (pKb) of from 7 to 14 having a piperidine skeleton.

The polymerization inhibitor content is preferably from 0.001 to 10% by weight, more preferably from 0.01 to 10% by weight, and still more preferably from 0.1 to 5% by weight based on the total solid content of polymerizable unsaturated group-containing compound in the image formation layer.

The thermosensitive image formation layer may contain a second polymerization inhibitor other than the above-described polymerization inhibitor. Examples of the second polymerization inhibitor include hydroquinone, p-methoxyphenol, di-t-butyl-p-cresol, pyrrogallol, t-butylcatechol, benzoquinone, 4,4′-thiobis (3-methyl-6-t-butylphenol), 2,2′-methylenebis (4-methyl-6-t-butylphenol), N-nitrosophenylhydroxylamine cerous salt, and 2-t-butyl-6-(3 t-butyl-6-hydroxy-5-methylbenzyl)-4-methylphenyl acrylate.

The thermosensitive image formation layer can contain a colorant. As the colorant can be used known materials including commercially available materials. Examples of the colorant include those described in revised edition “Ganryo Binran”, edited by Nippon Ganryo Gijutu Kyoukai (published by Seibunndou Sinkosha), or “Color Index Binran”. As the colorant, there are pigments.

As kinds of the pigments, there are black pigment, yellow pigment, red pigment, brown pigment, violet pigment, blue pigment, green pigment, fluorescent pigment, and metal powder pigment. Typical examples of the pigments include inorganic pigment (such as titanium dioxide, carbon black, graphite, zinc oxide, Prussian blue, cadmium sulfide, iron oxide, or chromate of lead, zinc, barium or calcium); and organic pigment (such as azo pigment, thioindigo pigment, anthraquinone pigment, anthanthrone pigment, triphenedioxazine pigment, vat dye pigment, phthalocyanine pigment or its derivative, or quinacridone pigment).

Among these pigments, pigment is preferably used which does not substantially have absorption in the absorption wavelength regions of a spectral sensitizing dye used according to a laser for exposure. The absorption of the pigment used is not more than 0.05, obtained from the reflection spectrum of the pigment measured employing an integrating sphere and employing light with the wavelength of the laser used. The pigment content is preferably 0.1 to 10% by weight, and more preferably 0.2 to 5% by weight, based on the total solid content of image formation layer.

A protective layer is preferably provided on the thermosensitive image formation layer. It is preferred that the protective layer (oxygen shielding layer) is highly soluble in a developer as described later (generally an alkaline solution). The protective layer preferably contains polyvinyl alcohol and polyvinyl pyrrolidone. Polyvinyl alcohol has the effect of preventing oxygen from transmitting and polyvinyl pyrrolidone has the effect of increasing adhesion between the oxygen shielding layer and the image formation layer adjacent thereto.

Besides the above two polymers, the oxygen shielding layer may contain a water soluble polymer such as polysaccharide, polyethylene glycol, gelatin, glue, casein, hydroxyethyl cellulose, carboxymethyl cellulose, methyl cellulose, hydroxyethyl starch, gum arabic, sucrose octacetate, ammonium alginate, sodium alginate, polyvinyl amine, polyethylene oxide, polystyrene sulfonic acid, polyacrylic acid, or a water soluble polyamide.

The photopolymerizable image formation layer in the invention is an image formation layer containing a polymerization initiator and a polymerizable unsaturated compound. As the polymerization initiator and polymerizable unsaturated compound, the same as those used in the thermosensitive image formation layer containing a polymerizable composition described above can be used.

As a photopolymerization initiator in the photopolymerizable image formation layer, a titanocene compound, a triarylmonoalkylborate compound, an iron-arene complex or a trihaloalkyl compound is preferably used.

As the titanocene compounds, there are compounds disclosed in Japanese Patent O.P.I. Publication Nos. 63-4-4183 and 2-291. Preferred examples thereof include bis(cyclopentadienyl)-Ti-dichloride, bis(cyclopentadienyl)-Ti-bisphenyl, bis(cyclopentadienyl)-Ti-bis-2,3,4,5,6-pentafluorophenyl, bis(cyclopentadienyl)-Ti-bis-2,3,5,6-tetrafluorophenyl, bis(cyclopentadienyl)-Ti-bis-2,4,6-trifluorophenyl, bis(cyclopentadienyl)-Ti-bis-2,6-difluorophenyl, bis(cyclopentadienyl)-Ti-bis-2,4-difluorophenyl, bis(methylcyclopentadienyl)-Ti-bis-2,3,4,5,6-pentafluorophenyl, bis(methylcyclopentadienyl)-Ti-bis-2,3,5,6-tetrafluorophenyl, bis(methylcyclopentadienyl)-Ti-bis-2,4-difluorophenyl (IRUGACURE 727L, produced by Ciba Specialty Co., Ltd.), bis(cyclopentadienyl)-bis(2,6-difluoro-3-(pyry-1-yl)phenyl)titanium (IRUGACURE 784, produced by Ciba Specialty Co., Ltd.), bis(cyclopentadienyl)-bis(2,4,6-trifluoro-3-(pyry-1-yl)phenyl)titanium, and his (cyclopentadienyl)-bis(2,4,6-trifluoro-3-(2,5-dimethylpyry-1-yl)phenyl)titanium.

As the monoalkyltriaryl borate compounds, there are those described in Japanese Patent O.P.I. Publication Nos. 62-150242 and 62-143044. Preferred examples of the monoalkyl-triaryl borate compounds include tetra-n-butyl ammonium n-butyl-trinaphthalene-1-yl-borate, tetra-n-butyl ammonium n-butyl-triphenyl-borate, tetra-n-butyl ammonium n-butyl-tri-(4-tert-butylphenyl)-borate, tetra-n-butyl ammonium n-hexyl-tri-(3-chloro-4-methylphenyl)-borate, and tetra-n-butyl ammonium n-hexyl-tri-(3-fluorophenyl)-borate.

As the iron arene complexes, there are those described in Japanese Patent O.P.I. Publication No. 59-2-9307. Preferred examples of the iron arene complex include η-benzene-(η-cyclopentadienyl)iron.hexafluorophosphate, η-cumene)-(η-cyclopentadienyl)iron.hexafluorophosphate, η-fluorene-(η-cyclopentadienyl)iron.hexafluorophosphate, η-naphthalene-(η-cyclopentadienyl)iron.hexafluorophosphate, η-xylene-(η-cyclopentadienyl)iron.hexafluorophosphate, and η-benzene-(η-cyclopentadienyl)iron.hexafluoroborate.

As the trihaloalkyl compound, the trihaloalkyl compound described above can be used.

Any other polymerization initiator can be also used in combination.

As the polymerization initiator, there are, for example, cumarin derivatives B-1 through B-22 disclosed in Japanese Patent O.P.I. Publication No. 8-129258, cumarin derivatives D-1 through D-32 disclosed in Japanese Patent O.P.I. Publication No. 2003-121901, cumarin derivatives 1 through 21 disclosed in Japanese Patent O.P.I. Publication No. 2002-363206, cumarin derivatives 1 through 40 disclosed in Japanese Patent O.P.I. Publication No. 2002-363207, cumarin derivatives 1 through 34 disclosed in Japanese Patent O.P.I. Publication No. 2002-363208, and cumarin derivatives 1 through 56 disclosed in Japanese Patent O.P.I. Publication No. 2002-363209.

### (Sensitizing Dyes)

A sensitizing dye used in the photopolymerizable image formation layer is preferably one which has an absorption maximum in the vicinity of the wavelength of light emitted from a light source used.

Examples of the sensitizing dyes, which have sensitivity to the wavelengths of visible to near infrared regions, i.e., have an absorption maximum in the wavelength ranges of from 350 to 1300 nm, include cyanines, phthalocyanines, merocyanines, porphyrins, spiro compounds, ferrocenes, fluorenes, fulgides, imidazoles, perylenes, phenazines, phenothiazines, polyenes, azo compounds, diphenylmethanes, triphenylmethanes, polymethine acridines, cumarines, ketocumarines, quinacridones, indigos, styryl dyes, pyrylium dyes, pyrromethene dyes, pyrazolotriazole compounds, benzothiazole compounds, barbituric acid derivatives, thiobarbituric acid derivatives, ketoalcohol borate complexes, and compounds disclosed in European Patent No. 568,993, U.S. Pat. Nos. 4,508,811 and 5,227,227, and Japanese Patent O.P.I. Publication Nos. 2001-125255 and 11-271969.

Examples in which the above polymerization initiators are used in combination with the sensitizing dye are disclosed in Japanese Patent O.P.I. Publication Nos. 2001-125255 and 11-271969.

The sensitizing dye content of the light sensitive layer is preferably an amount giving a reflection density of the planographic printing plate material surface of from 0.1 to 1.2 to wavelength of light used for exposure. The sensitizing dye content giving such an amount of the image formation layer is ordinarily from 0.5 to 10% by weight, although it is different due to molecular extinction coefficient or crystallinity in the image formation layer of used dyes.

The photopolymerizable image formation layer can contain the polymer binder described above as a polymer binder.

### (Additives)

In the invention, the photopolymerizable image formation layer in the invention may contain a hindered phenol compound, a hindered amine compound or other polymerization inhibitors in addition to the compounds described above, in order to prevent undesired polymerization of the ethylenically unsaturated monomer during the manufacture or storage of the light sensitive planographic printing plate material.

Examples of the hindered amine compound include bis(1,2,2,6,6-pentamethyl-4-piperidyl)sebacate, bis(2,2,6,6-tetramethyl-4-piperidyl)sebacate, 1-[2-{3-(3,5-di-t-butyl-hydroxyphenyl)propionyloxy}ethyl]-4-[2-{3-(3,5-di-t-butyl-hydroxyphenyl)propionyloxy}ethyl]-2,2,6,6-tetramethylpiperidine, 4-benzoyloxy-2,2,6,6-tetramethylpiperidine, and 8-acetyl-3-dodecyl-7,7,9,9-tetramethyl-1,3,8-triazaspiro-[4.5]decane-2,4-dione.

Examples of another polymerization inhibitor include hydroquinone, p-methoxyphenol, di-t-butyl-p-cresol, pyrrogallol, t-butylcatechol, benzoquinone, 4,4′-thiobis (3-methyl-6-t-butylphenol), 2,2′-methylenebis (4-methyl-6-t-butylphenol), N-nitrosophenylhydroxylamine cerous salt, and hindered amines such as 2,2,6,6-tetramethylpiperidine derivatives -butyl-6-(3-t-butyl-6-hydroxy-5-methylbenzyl)-4-methylphenyl acrylate.

The polymerization inhibitor content is preferably 0.01 to 5% by weight based on the total solid content of the composition above. Further, in order to prevent polymerization induced by oxygen, a higher fatty acid such as behenic acid or a higher fatty acid derivative such as behenic amide may be added to the light sensitive layer, or may be localized on the surface of the light sensitive layer in the course of drying after coating. The higher fatty acid or higher fatty acid derivative content is preferably 0.5 to 10% by weight based on the total solid content of the composition.

The photopolymerizable image formation layer can further contain the colorant as described above in the thermosensitive image formation layer.

### (Coating)

Solvents used in the preparation of the image formation layer coating solution for the image formation layer in the invention include an alcohol such as sec-butanol, isobutanol, n-hexanol, or benzyl alcohol; a polyhydric alcohol such as diethylene glycol, triethylene glycol, tetraethylene glycol, or 1,5-pentanediol; an ether such as propylene glycol monobutyl ether, dipropylene glycol monomethyl ether, or tripropylene glycol monomethyl ether; a ketone or aldehyde such as diacetone alcohol, cyclohexanone, or methyl cyclohexanone; and an ester such as ethyl lactate, butyl lactate, diethyl oxalate, or methyl benzoate.

The image formation layer coating solution for the image formation layer is coated on a support according to a conventional method, and dried to obtain a light sensitive planographic printing plate material. Examples of the coating method include an air doctor coating method, a blade coating method, a wire bar coating method, a knife coating method, a dip coating method, a reverse roll coating method, a gravure coating method, a cast coating method, a curtain coating method, and an extrusion coating method.

The drying temperature of a coated photopolymerizable image formation layer is preferably from 60 to 160° C., more preferably from 80 to 140° C., and still more preferably from 90 to 120° C.

### (Protective Layer)

A protective layer is preferably provided on the image formation layer in the invention. It is preferred that the protective layer (oxygen shielding layer) is highly soluble in a developer (generally an alkaline solution).

Materials constituting the protective layer are preferably polyvinyl alcohol, polysaccharide, polyvinyl pyrrolidone, polyethylene glycol, gelatin, glue, casein, hydroxyethyl cellulose, carboxymethyl cellulose, methyl cellulose, hydroxyethyl starch, gum arabic, sucrose octacetate, ammonium alginate, sodium alginate, polyvinyl amine, polyethylene oxide, polystyrene sulfonic acid, polyacrylic acid, or a water soluble polyamide. These materials may be used alone or in combination. Especially preferred material is polyvinyl alcohol.

A coating solution for the protective layer is obtained by dissolving the materials described above in a solvent. The coating liquid is coated on the light sensitive layer and dried to form a protective layer. The dry thickness of the protective layer is preferably from 0.1 to 5.0 μm, and more preferably from 0.5 to 3.0 μm. The protective layer may contain a surfactant or a matting agent.

The same coating method as described above in the image formation layer applies in the protective layer coating method. The drying temperature of the protective layer is preferably lower than that of the image formation layer. The former is preferably not less than 10° C. lower than that of the latter, and more preferably not less than 20° C. lower than that of the latter. The former is at most 50° C. lower than that of the latter.

Further, the drying temperature of the protective layer is preferably lower than a glass transition temperature (Tg) of the binder contained in the image formation layer. The drying temperature of the protective layer is preferably not less than 20° C. lower than Tg of the binder contained in the image formation layer, and more preferably not less than 40° C. lower than Tg of the binder contained in the image formation layer. The drying temperature of the protective layer is preferably at most 60° C. lower than Tg of the binder contained in the image formation layer.

### (Plate-Making and Printing)

The light sensitive planographic printing plate material of the invention is imagewise exposed to form an image, and then optionally developed to obtain a printing plate which is applied for printing.

The light sources for the imagewise exposure include, for example, a laser, an emission diode, a xenon flush lamp, a halogen lamp, a carbon arc light, a metal halide lamp, a tungsten lamp, a high pressure mercury lamp, and a non-electrode light source.

When the light sensitive planographic printing plate precursor is imagewise exposed at one time, a mask material having a negative image pattern made of a light shielding material is provided on the image formation layer to be in close contact with the image formation layer, and exposure is carried out through the mask.

When an array light such as an emission diode array is used or exposure using a halogen lamp, a metal halide lamp or a tungsten lamp is controlled using an optical shutter material such as liquid crystal or PLZT, a digital exposure according to an image signal is possible and preferable. In this case, direct writing is possible without using any mask material.

When a laser is used for exposure, which can be condensed in the beam form, scanning exposure according to an image can be carried out, and direct writing is possible without using any mask material. When the laser is employed for imagewise exposure, a highly dissolved image can be obtained, since it is easy to condense its exposure spot in minute size.

In the invention, it is preferred that imagewise exposure is carried out employing laser light to form an image.

That is, a printing method is preferred in which the planographic printing plate material of any one of claims 9 through 12 is imagewise exposed to laser light to form an image and printing is carried out employing the exposed planographic printing plate material.

A laser scanning method by means of a laser beam includes a method of scanning on an outer surface of a cylinder, a method of scanning on an inner surface of a cylinder and a method of scanning on a plane. In the method of scanning on an outer surface of a cylinder, laser beam exposure is conducted while a drum around which a recording material is wound is rotated, in which main scanning is represented by the rotation of the drum, while sub-scanning is represented by the movement of the laser beam. In the method of scanning on an inner surface of a cylinder, a recording material is fixed on the inner surface of a drum, a laser beam is emitted from the inside, and main scanning is carried out in the circumferential direction by rotating a part of or an entire part of an optical system, while sub-scanning is carried out in the axial direction by moving straight a part of or an entire part of the optical system in parallel with a shaft of the drum. In the method of scanning on a plane, main scanning by means of a laser beam is carried out through a combination of a polygon mirror, a galvano mirror and an Fθ lens, and sub-scanning is carried out by moving a recording medium. The method of scanning on an outer surface of a cylinder, and the method of scanning on an inner surface of a cylinder are preferred in optical system accuracy and high density recording.

When the exposed light sensitive planographic printing plate material is developed, an automatic developing machine is ordinarily used.

Printing is carried out employing a conventional printing press.

In recent years, printing ink containing no petroleum volatile organic compound (VOC) has been developed and used in view of environmental protection. The present invention provides excellent effects in employing such a printing ink for environmental protection.

In the invention, a printing method is preferred which comprises the steps of imagewise exposing to laser light the planographic printing plate material of items 9 through 12 described previously, and carrying out printing employing the exposed planographic printing plate material and printing ink containing no petroleum volatile organic compound (VOC). Examples of a printing ink for environmental protection include soybean oil ink “Naturalith 100” produced by Dainippon Ink Kagaku Kogyo Co., Ltd., VOC zero ink “TK HIGH ECO NV” produced by Toyo Ink Manufacturing Co., Ltd., and process ink “Hicelvo” produced by Tokyo Ink Co., Ltd.

### Examples

Next, the present invention will be explained employing examples, but the present invention is not limited thereto. In the examples, “parts” represents “parts by weight”, unless otherwise specified.

### (Preparation of Supports 1 Through 25)

A 0.3 mm thick aluminum plate (material 1052, containing not less than 99.3% of Al, 0.003% of Na, 0.020% of Mg, 0.08% of Si, 0.06% of Ti, 0.004% of Mn, 0.32% of Fe, 0.004% of Ni, 0.002% of Cu, 0.015% of Zn, 0.007% of Ga, and 0.001% of Cr) was subjected to the following treatments.

### (1) Etching by Alkali Solution

(1-1)

The aluminum plate was immersed in a 3% sodium hydroxide solution of 50° C. for 20 seconds for etching treatment, wherein the dissolution amount of the aluminum was 2.8 g/m².

(1-2)

The aluminum plate was immersed in a 0.45% sodium hydroxide solution of 60° C. for 40 seconds for etching treatment, wherein the dissolution amount of the aluminum was 1.6 g/m².

(1-3)

The aluminum plate was immersed in a 7% sodium hydroxide solution of 30° C. for 40 seconds for etching treatment, wherein the dissolution amount of the aluminum was 5.2 g/m².

The alkali solution etched aluminum plate was washed with water.

### (2) Neutralizing Treatment by Acidic Solution

(2-1)

The resulting water washed aluminum plate was immersed in a 3% nitric acid solution of 25° C. for 10 seconds for neutralization.

The neutralized aluminum plate was washed with water.

### (3) First Electrolytically Surface Roughening Employing Alternating Current

(3-1)

The aluminum plate, which had been neutralized in an acidic solution and washed with water, was electrolytically surface-roughened at 30° C. in a solution having a hydrochloric acid concentration of 11 g/liter, an acetic acid concentration of 10 g/liter, and an aluminum concentration of 1.5 g/liter, employing a sine waveform alternating current from a 60 Hz alternating-current power supply.

Current density and quantity of electricity supplied during the electrolytic surface roughening were as shown in Table 1.

(3-2)

The aluminum plate, which had been neutralized in an acidic solution and washed with water, was electrolytically surface-roughened at 30° C. in a solution having a nitric acid concentration of 11 g/liter and an aluminum concentration of 1.5 g/liter, employing a sine waveform alternating current from a 60 Hz alternating-current power supply.

Current density and quantity of electricity supplied during the surface roughening were as shown in Table 1.

After the first electrolytically surface roughening, the aluminum plate was washed with water.

### (4) Etching Treatment After First Electrolytically Surface Roughening Employing Alternating Current

### (4A-1)

The aluminum plate, which had been electrolytically surface roughened and washed with water, was immersed in an aqueous 3% sodium hydroxide solution of 60° C. for 15 seconds for etching treatment.

The dissolution amount of the aluminum was 4.0 g/m².

### (4A-2)

The aluminum plate, which had been electrolytically surface roughened and washed with water, was immersed in an aqueous 3% sodium hydroxide solution of 50° C. for 20 seconds for etching treatment.

The dissolution amount of the aluminum was 2.8 g/m².

### (4A-3)

The aluminum plate, which had been electrolytically surface roughened and washed with water, was immersed in an aqueous 3% sodium hydroxide solution of 50° C. for 30 seconds for etching treatment.

The dissolution amount of the aluminum was 5.1 g/m².

### (4B-1)

The aluminum plate, which had been electrolytically surface roughened and washed with water, was immersed in an aqueous 40% phosphoric acid solution of 60° C. for 60 seconds for etching treatment. The dissolution amount of the aluminum was 4.0 g/m². (Inventive)

### (4B-2)

The aluminum plate, which had been electrolytically surface roughened and washed with water, was immersed in an aqueous 40% phosphoric acid solution of 50° C. for 60 seconds for etching treatment. The dissolution amount of the aluminum was 2.9 g/m².

### (4B-3)

The aluminum plate, which had been electrolytically surface roughened and washed with water, was immersed in an aqueous 40% sodium hydroxide solution of 70° C. for 60 seconds for etching treatment. The dissolution amount of the aluminum was 5.2 g/m².

The aluminum plate, which had been etched with the aqueous sodium hydroxide solution, was immersed in a 3% nitric acid solution of 25° C. for 10 seconds for neutralization treatment, and washed with water. While the aluminum plate, which had been etched with the aqueous phosphoric acid solution, was only washed with water.

### (5) Second Electrolytically Surface Roughening Employing Alternating Current

(5-1)

The aluminum plate, which had been etched, neutralized and washed with water, was electrolytically surface-roughened at 30° C. in an aqueous solution having a hydrochloric acid concentration of 11 g/liter, an acetic acid concentration of 10 g/liter, and an aluminum concentration of 1.5 g/liter, employing a sine waveform alternating current from a 60 Hz alternating-current power supply.

Current density and quantity of electricity supplied during the electrolytic surface roughening are as shown in Table 2.

(5-2)

The aluminum plate, which had been etched, neutralized and washed with water, was electrolytically surface-roughened at 30° C. in an aqueous solution having a nitric acid concentration of 11 g/liter, and an aluminum concentration of 1.5 g/liter, employing a sine waveform alternating current from a 60 Hz alternating-current power supply.

Current density and quantity of electricity supplied during the surface electrolytic roughening were as shown in Table 2.

After the second electrolytically surface roughening, the aluminum plate was washed with water.

(6) Desmut Treatment after Second Electrolytically Surface Roughening Treatment
(6-1)

The aluminum plate, which had been electrolytically surface roughened and washed with water, was subjected to desmut treatment at 56° C. for 12 seconds in an aqueous solution having a phosphoric acid concentration of 75 g/liter and an aluminum concentration of 1.5 g/liter. The amount of the undissolved aluminum was 0.1 g/m⁻¹.

(6-2)

The aluminum plate, which had been electrolytically surface roughened and washed with water, was subjected to desmut treatment at 56° C. for 8 seconds in an aqueous solution having a phosphoric acid concentration of 75 g/liter and an aluminum concentration of 1.5 g/liter. The amount of the undissolved aluminum was 0.25 g/m².

(6-3)

The aluminum plate, which had been electrolytically surface roughened and washed with water, was subjected to desmut treatment at 56° C. for 5 seconds in an aqueous solution having a phosphoric acid concentration of 75 g/liter and an aluminum concentration of 1.5 g/liter. The amount of the undissolved aluminum was 0.45 g/m².

(6-4)

The aluminum plate, which had been electrolytically surface roughened and washed with water, was subjected to desmut treatment at 56° C. for 20 seconds in an aqueous solution having a phosphoric acid concentration of 75 g/liter and an aluminum concentration of 1.5 g/liter. The amount of the undissolved aluminum was 0.04 g/m².

After the desmut treatment, the aluminum plate was washed with water.

Thus, an aluminum plate was subjected to processing as shown in Tables 1 and 2.

Subsequently, employing direct current, the resulting aluminum plate was subjected to anodizing treatment in a 25° C. aqueous solution containing a sulfuric acid concentration of 200 g/liter and a dissolved aluminum concentration of 1.5 g/liter at a current density of 5 A/dm² to form an anodization film of 20 mg/dm², and washed with distilled water.

Subsequently, the anodized aluminum plate was dipped in a 0.2% aqueous polyvinyl phosphonic acid solution at 60° C. for 40 seconds, washed with distilled water, and dried for 30 seconds employing 150° C. air. Thus, supports 1 through 15 were prepared.

The arithmetic average roughness of these supports is shown in Table 2.

### (Measurement of Arithmetic Average Roughness Ra)

The arithmetic average roughness (Ra) of the supports was two-dimensionally measured five times according to ISO4287, employing a Contact-type roughness meter SE 1700α produced by Kosaka Kenkyuusho, and an average thereof was defined as the arithmetic average roughness in the invention.

The conditions of the measurement are as follows:

### Cutoff: 0.8 mm

Measured length: 4 mm
Scanning speed: 0.1 mm/second
Stylus tip diameter: 2 μm

### (Measurement of Undissolved Smut Amount)

The aluminum plate, which had been subjected to desmut treatment, washed with water and dried, was immersed in an aqueous phosphoric acid chromic acid solution at 93° C. for 3 minutes, washed with water, and dried, the aqueous phosphoric acid chromic acid solution being prepared by dissolving 35 ml of a 85% phosphoric acid solution and 20 g of chromium (IV) oxide in 1 liter of water. The undissolved smut amount can be obtained from difference between weights of the aluminum plates before and after the immersion.

TABLE 1

| | | | | First Electrolytically Surface-roughening | | | | | |
|---|---|---|---|---|---|---|---|---|---|
| | Etching Treatment | | | Treatment | | | | | |
| | with Alkali Solution | | | | | Elec- | | Etching Treatment | |
| Sup- | | Aluminum | Neutralizing | | Current | trolytic | Quantity of | | Aluminum |
| port | Con- | Dissolution | Treatment | Solution | Density | Time | Electricity | Con- | Dissolution |
| No. | dition | Amount g/m² | Condition | Condition | D1(A/dm²) | t1(sec) | Q1(A · second/dm²) | dition | Amount g/m² |
| 1 | 1-1 | 2.8 | 2-1 | 3-1 | 45 | 15 | 675 | 4A-1 | 4.0 |
| 2 | 1-1 | 2.8 | 2-1 | 3-1 | 45 | 15 | 675 | 4A-1 | 4.0 |
| 3 | 1-1 | 2.8 | 2-1 | 3-1 | 45 | 15 | 675 | 4B-1 | 4.0 |
| 4 | 1-1 | 2.8 | 2-1 | 3-1 | 45 | 15 | 675 | 4B-1 | 4.0 |
| 5 | 1-2 | 1.6 | 2-1 | 3-1 | 45 | 15 | 675 | 4B-1 | 4.0 |
| 6 | 1-3 | 5.2 | 2-1 | 3-1 | 45 | 15 | 675 | 4B-1 | 4.0 |
| 7 | 1-1 | 2.8 | 2-1 | 3-1 | 45 | 15 | 675 | 4A-2 | 2.8 |
| 8 | 1-1 | 2.8 | 2-1 | 3-1 | 45 | 15 | 675 | 4A-3 | 5.1 |
| 9 | 1-1 | 2.8 | 2-1 | 3-1 | 45 | 15 | 675 | 4B-2 | 2.9 |
| 10 | 1-1 | 2.8 | 2-1 | 3-1 | 45 | 15 | 675 | 4B-3 | 5.2 |
| 11 | 1-1 | 2.8 | 2-1 | 3-1 | 45 | 15 | 675 | 4A-1 | 4.0 |
| 12 | 1-1 | 2.8 | 2-1 | 3-1 | 45 | 15 | 675 | 4A-1 | 4.0 |
| 13 | 1-1 | 2.8 | 2-1 | 3-1 | 45 | 20 | 900 | 4A-1 | 4.0 |
| 14 | 1-1 | 2.8 | 2-1 | 3-1 | 45 | 10 | 450 | 4A-1 | 4.0 |
| 15 | 1-1 | 2.8 | 2-1 | 3-1 | 30 | 22 | 660 | 4A-1 | 4.0 |
| 16 | 1-1 | 2.8 | 2-1 | 3-1 | 45 | 15 | 675 | 4A-1 | 4.0 |
| 17 | 1-1 | 2.8 | 2-1 | 3-1 | 45 | 15 | 675 | 4A-1 | 4.0 |
| 18 | 1-1 | 2.8 | 2-1 | 3-1 | 45 | 15 | 675 | 4A-1 | 4.0 |
| 19 | 1-1 | 2.8 | 2-1 | 3-1 | 45 | 15 | 675 | 4A-1 | 4.0 |
| 20 | 1-1 | 2.8 | 2-1 | 3-1 | 45 | 21 | 945 | 4A-1 | 4.0 |
| 21 | 1-1 | 2.8 | 2-1 | 3-1 | 45 | 21 | 945 | * | |
| 22 | 1-1 | 2.8 | 2-1 | 3-2 | 45 | 15 | 675 | 4A-1 | 4.0 |
| 23 | 1-1 | 2.8 | 2-1 | 3-1 | 45 | 15 | 675 | 4A-1 | 4.0 |
| 24 | 1-1 | 2.8 | 2-1 | 3-2 | 45 | 21 | 945 | 4A-1 | 4.0 |

| | | | | | | | | |
|---|---|---|---|---|---|---|---|---|
| 25 | 1-1 | 2.8 | 2-1 | 3-2 | 45 | 21 | 945 | * |

* Etching treatment was not carried out.

TABLE 2

| | Second Electrolytically Surface-roughening Treatment | | | | | | | |
|---|---|---|---|---|---|---|---|---|
| Sup- | | Current | Electrolytic | Quantity of | Desmut Treatment | | | |
| port | Solution | Density | Time | Electricity | | Undissolved Smut | Ra | Re- |
| No. | Condition | D1(A/dm²) | t1(sec) | Q1(A · second/dm²) | Condition | Amount g/m² | (μm) | marks |
| 1 | 5-1 | 20 | 15 | 300 | 6-1 | 0.10 | 0.50 | Inv. |
| 2 | 5-1 | 20 | 15 | 300 | 6-2 | 0.25 | 0.49 | Inv. |
| 3 | 5-1 | 20 | 15 | 300 | 6-1 | 0.10 | 0.50 | Inv. |
| 4 | 5-1 | 20 | 15 | 300 | 6-2 | 0.25 | 0.49 | Inv. |
| 5 | 5-1 | 20 | 15 | 300 | 6-1 | 0.10 | 0.53 | Inv. |
| 6 | 5-1 | 20 | 15 | 300 | 6-1 | 0.10 | 0.43 | Inv. |
| 7 | 5-1 | 20 | 15 | 300 | 6-1 | 0.10 | 0.52 | Comp. |
| 8 | 5-1 | 20 | 15 | 300 | 6-1 | 0.10 | 0.41 | Comp. |
| 9 | 5-1 | 20 | 15 | 300 | 6-1 | 0.10 | 0.52 | Comp. |
| 10 | 5-1 | 20 | 15 | 300 | 6-1 | 0.10 | 0.41 | Comp. |
| 11 | 5-1 | 20 | 15 | 300 | 6-3 | 0.40 | 0.51 | Comp. |
| 12 | 5-1 | 20 | 15 | 300 | 6-4 | 0.04 | 0.49 | Comp. |
| 13 | 5-1 | 20 | 15 | 300 | 6-1 | 0.10 | 0.61 | Comp. |
| 14 | 5-1 | 20 | 15 | 300 | 6-1 | 0.10 | 0.39 | Comp. |
| 15 | 5-1 | 20 | 15 | 300 | 6-1 | 0.10 | 0.48 | Comp. |
| 16 | 5-1 | 20 | 3 | 60 | 6-1 | 0.10 | 0.45 | Comp. |
| 17 | 5-1 | 20 | 22 | 440 | 6-1 | 0.10 | 0.55 | Comp. |
| 18 | 5-1 | 10 | 30 | 300 | 6-1 | 0.10 | 0.48 | Comp. |
| 19 | 5-1 | 35 | 9 | 315 | 6-1 | 0.10 | 0.56 | Comp. |
| 20 | ** | | | | | | 0.48 | Comp. |
| 21 | *** | | | | 6-1 | 0.10 | 0.51 | Comp. |
| 22 | 5-1 | 20 | 15 | 300 | 6-1 | 0.10 | 0.49 | Comp. |
| 23 | 5-2 | 20 | 15 | 300 | 6-1 | 0.10 | 0.51 | Comp. |

| 24 | ** | | | 0.47 | Comp. |
|---|---|---|---|---|---|
| 25 | *** | 6-1 | 0.10 | 0.50 | Camp. |

Inv.: Inventive,
Comp.: Comparative
** Second electrolytically surface-roughening treatment and desmut treatment were not carried out.
*** Second electrolytically surface-roughening treatment was not carried out.

### (Preparation of Photopolymer Type Planographic Printing Plate Material Samples 1 Through 25 for FD-YAG Laser (532 μm) Exposure)

The following photopolymerizable light sensitive layer coating solution was coated on each of the supports 1 through through a wire bar, and dried at 95° C. for 1.5 minutes to give a light sensitive layer with a dry thickness of 1.6 g/m², and then the following protective layer coating solution was coated on the resulting light sensitive layer through an applicator and dried at 75° C. for 1.5 minutes to give a protective layer with a dry thickness of 1.7 g/m². Thus, photopolymerizable light sensitive planographic printing plate material samples were prepared.

(Photopolymerizable Light Sensitive Layer Coating Solution)

| | | |
|---|---|---|
| Polymer binder B-1 (described below) | 40.0 | parts |
| Sensitizing dyes D1 (described below) and | 3.0 | parts |
| D2 (described below)(1:1 by weight) | | |
| Photopolymerization initiator | 4.0 | parts |
| (η-Cumene-(η-cyclopentadienyl)iron hexa- | | |
| fluorophosphate) | | |
| Addition polymerizable ethylenically | 40.0 | parts |
| unsaturated monomer M-3 (described previously) | | |
| Addition polymerizable ethylenically | 15.0 | parts |
| unsaturated monomer NK ESTER G (polyethylene glycol | | |
| dimethacrylate produced by Shinnakamura Kagaku | | |
| Co., Ltd.) | | |
| Hindered amine compound | 0.1 | parts |
| (LS-770 produced by Sankyo Co., Ltd.) | | |
| Trihaloalkyl compound E-1 (described below) | 1.0 | parts |
| Phthalocyanine pigment | 4.0 | parts |
| (MHI #454 produced by Mikuni Sikisosha) | | |
| Fluorine-contained surfactant | 0.5 | parts |
| (F-178K produced by Dainippon Ink Kagaku Kogyo | | |
| Co., Ltd.) | | |
| Methyl ethyl ketone | 80 | parts |
| Cyclohexanone | 820 | parts |

### (Synthesis of Polymer Binder B-1)

One hundred and twenty-five parts (1.25 mol) of methyl methacrylate, 12 parts (0.1 mol) of ethyl methacrylate, 63 parts (0.73 mol) of methacrylic acid, 240 parts of cyclohexanone, 160 parts of isopropyl alcohol, and 5 parts of α,α′-azobisisobutyro-nitrile were put in a three neck flask under nitrogen atmosphere, and reacted under nitrogen atmosphere for 6 hours at 80° C. in an oil bath. After that, 4 parts of triethylbenzylammonium chloride and 52 parts (0.73 mol) of glycidyl methacrylate were further added to the mixture, and reacted at 25° C. for 3 hours. Thus, polymer binder B-1 was obtained. The weight average molecular weight of the polymer binder B-1 was 55,000 (in terms of polystyrene), measured according to GPC.

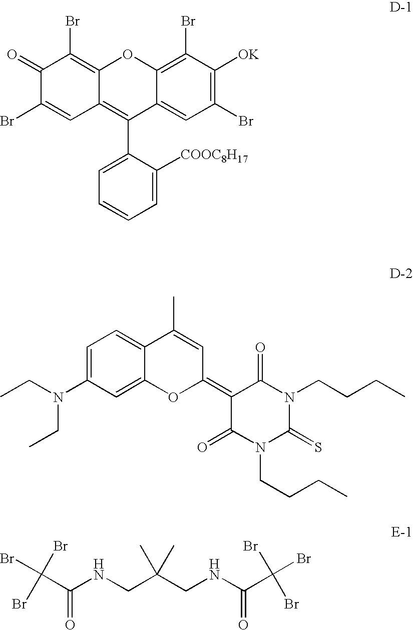

(Protective Layer Coating Solution)

| | | |
|---|---|---|
| Polyvinyl alcohol (GL-05, produced | 84 | parts |
| by Nippon Gosei Kagaku Co., Ltd.) | | |
| Polyvinyl pyrrolidone (K-30, produced | 15 | parts |
| by ISP Japan Co., Ltd.) | | |
| Surfactant (Surfinol 465, | 0.5 | parts |
| produced by Nisshin Kagaku Kogyo Co., Ltd.) | | |
| Water | 900 | parts |

### (Image Formation)

Employing a CTP exposure device Tigercat (produced by ECRM Co., Ltd.) installed with FD-YAG laser, each of the photopolymerizable light sensitive planographic printing plate material samples obtained above was imagewise exposed at exposure energy of 200 μJ/cm² and at a resolution of 2400 dpi (“dpi” means a dot number per 1 inch, i.e., 2.54 cm) to obtain an image with a screen line number of 175.

The image included a solid image and a dot image with a dot area of 1 to 99%. Subsequently, the exposed sample was subjected to development treatment employing a CTP automatic developing machine (PHW 23-V produced by Technigraph Co., Ltd.) to obtain a planographic printing plate. Herein, the developing machine comprised a preheating section for preheating the exposed sample, a pre-washing section for removing the protective layer before development, a development section charged with developer having the following developer composition, a washing section for removing the developer remaining on the developed sample after development, and a gumming section charged with a gumming solution (a solution obtained by diluting GW-3, produced by Mitsubishi Chemical Co., Ltd., with water by a factor of 2) for protecting the surface of the developed sample. Thus, planographic printing plate samples 1 through 25 were obtained.

Herein, preheating was carried out at a surface temperature of 115° C. for 15 seconds. Time taken from completion of exposure till to arrival at the preheating section was within 30 seconds.

Developer (Aqueous solution containing the following additives)

| | | |
|---|---|---|
| Potassium silicate solution | 40.0 | g/liter |
| (containing 26% by weight of SiO₂ and 13.5% | | |
| by weight of K₂O) | | |
| Potassium hydroxide | 4.0 | g/liter |
| Ethylenediaminetetraacetic acid | 0.5 | g/liter |
| Sodiumsulfo-polyoxyethylene (13) | 20.0 | g/liter |
| naphthyl ether | | |

Water was added to make a 1 liter developer. PH of the developer was 12.3.

### (Printing Method)

Employing the resulting printing plate samples, printing was carried out on a press (DAIYA1F-1 produced by Mitsubishi Jukogyo Co., Ltd.), wherein coated paper, printing ink (Soybean oil ink, “Naturalith 100” produced by Dainippon Ink Kagaku Co., Ltd.), and dampening water (SG-51, H solution produced by Tokyo Ink Co., Ltd., Concentration: 1.5%) were used.

### (Printing Durability)

The exposure was linearly corrected, and a dot image with a dot area of 1 through 99% was linearly reproduced on the resulting printing plate samples. Printing was carried out as above, and the number of prints printed until time when an image of a dot area of 5% was not reproduced was evaluated as a measure of printing durability. The more the number is, the higher the printing durability. The results are shown in Table 3.

### (Resistance to Blanket Contamination)

Printing was carried out as above, and when 50000 copies were printed, printing was suspended, and ink density of ink accumulated on portions corresponding to non-image portions of the blanket was determined as a measure of resistance to blanket contamination.

The less the ink density is, the better the resistance to blanket contamination. The results are shown in Table 3.

(Background Contamination after Suspension of Printing)

After blanket contamination evaluation above, the printing plate sample was allowed to stand for one hour, and then printing was restarted. Contamination at non-image portions was observed and evaluated as a measure of resistance to background contamination after suspension of printing according to the following evaluation ranking. The results are shown in Table 3.

### Evaluation Ranking

A: No contamination was produced.
B: Contamination was produced, but disappeared before 20 copies were printed.
C: Contamination was produced, but disappeared before 50 to 100 copies were printed.
D: Contamination was produced, but disappeared after 100 or more copies were printed.
E: Contamination was produced and did not disappear.

TABLE 3

| | | | | Resistance to | |
|---|---|---|---|---|---|
| | | | | Background | |
| | | | Resistance to | Contamination | |
| Sam- | Sup- | Printing | Blanket | after Suspension | |
| ple | port | Durability | Contamination | of Printing | Re- |
| No. | No. | (Number) | (Ink Density) | (Ranking) | marks |
| 1 | 1 | 400000 | 0.05 | A | Inv. |
| 2 | 2 | 400000 | 0.05 | A | Inv. |
| 3 | 3 | 400000 | 0.05 | A | Inv. |
| 4 | 4 | 400000 | 0.05 | A | Inv. |
| 5 | 5 | 400000 | 0.05 | B | Inv. |
| 6 | 6 | 380000 | 0.05 | A | Comp |
| 7 | 7 | 400000 | 0.10 | C | Comp |
| 8 | 8 | 300000 | 0.05 | A | Comp |
| 9 | 9 | 400000 | 0.10 | C | Comp |
| 10 | 10 | 300000 | 0.05 | A | Comp |
| 11 | 11 | 400000 | 0.12 | C | Comp |
| 12 | 12 | 300000 | 0.05 | A | Comp |
| 13 | 13 | 350000 | 0.10 | D | Comp |
| 14 | 14 | 300000 | 0.05 | A | Comp |
| 15 | 15 | 350000 | 0.10 | C | Comp |
| 16 | 16 | 300000 | 0.10 | B | Comp |
| 17 | 17 | 350000 | 0.08 | C | Comp |
| 18 | 18 | 350000 | 0.05 | C | Comp |
| 19 | 19 | 300000 | 0.08 | C | Comp |
| 20 | 20 | 250000 | 0.05 | A | Comp |
| 21 | 21 | 250000 | 0.08 | C | Comp |
| 22 | 22 | 200000 | 0.15 | D | Comp |
| 23 | 23 | 150000 | 0.13 | D | Comp |
| 24 | 24 | 150000 | 0.18 | D | Comp |
| 25 | 25 | 150000 | 0.20 | D | Comp |

Inv.: Inventive,
Comp.: Comparative

As is apparent from Table 3, the inventive planographic printing plate material samples employing the support manufactured according to the manufacturing method of the invention provide high printing durability, high resistance to blanket contamination and high resistance to background contamination after suspension of printing.

(Preparation of Photopolymer Type Planographic Printing Plate Material Samples 26 through 50 for Violet Light Source Exposure)

The following photopolymerizable light sensitive layer coating solution was coated on each of the supports 1 through 25 through a wire bar, and dried at 95° C. for 1.5 minutes to give a light sensitive layer with a dry thickness of 1.9 g/m², and then the protective layer coating solution described above was coated on the resulting light sensitive layer through an applicator and dried at 75° C. for 1.5 minutes to give a protective layer with a dry thickness of 1.7 g/m². Thus, photopolymerizable light sensitive planographic printing plate material samples were prepared.

(Photopolymerizable Light Sensitive Layer Coating Solution)

| | | |
|---|---|---|
| Polymer binder B-1 (described previously) | 40.0 | parts |
| Photopolymerization initiator | 3.0 | parts |
| (η-Cumene-(η-cyclopentadienyl)iron hexafluorophosphate) | | |
| Sensitizing dyes D3 and D4 (1:1 by weight) | 4.0 | parts |
| Addition polymerizable ethylenically | 40.0 | parts |
| unsaturated monomer M-3 (described previously) | | |
| Addition polymerizable ethylenically | 7.0 | parts |
| unsaturated monomer NK ESTER G (polyethylene glycol | | |
| dimethacrylate produced by Shinnakamura Kagaku Co., | | |
| Ltd.) | | |
| Cationically polymerizable compound C-1 | 8.0 | parts |
| (described below) | | |
| Hindered amine compound | 0.1 | parts |
| (LS-770 produced by Sankyo Co., Ltd.) | | |
| Trihaloalkyl compound E-1 (described above) | 5.0 | parts |
| Phthalocyanine pigment | 7.0 | parts |
| (MHI #454 produced by Mikuni Sikisosha) | | |
| Fluorine-contained surfactant | 0.5 | parts |
| (F-178K produced by Dainippon Ink Kagaku Kogyo Co., | | |
| Ltd.) | | |
| Methyl ethyl ketone | 80 | parts |
| Cyclohexanone | 820 | parts |

D-3

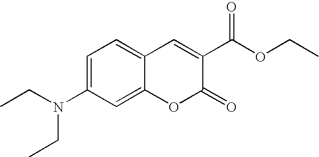

D-4

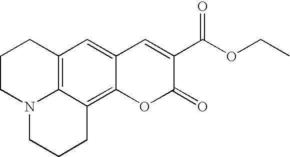

C-1

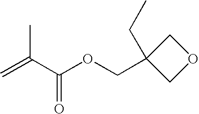

### (Image Formation)

Employing a plate setter (modified Tigercat ECRM) installed with a 408 nm laser having an output power of 30 mW, each of the photopolymerizable light sensitive planographic printing plate material samples obtained above was imagewise exposed at exposure energy of 50 μJ/cm² and at a resolution of 2400 dpi (“dpi” means a dot number per 1 inch, i.e., 2.54 cm) to obtain an image with a screen line number of 175.

The image included a solid image and a dot image with a dot area of 1 to 99%.

Subsequently, the exposed sample was subjected to development treatment employing a CTP automatic developing machine (PHW 23-V produced by Technigraph Co., Ltd.) to obtain a planographic printing plate. Herein, the developing machine comprised a preheating section for preheating the exposed sample, a pre-washing section for removing the protective layer before development, a development section charged with developer as described above, a washing section for removing the developer remaining on the developed sample after development, and a gumming section charged with a gumming solution (a solution obtained by diluting GW-3, produced by Mitsubishi Chemical Co., Ltd., with water by a factor of 2) for protecting the surface of the developed sample. Thus, planographic printing plate samples 26 through 50 were obtained.

Herein, preheating was carried out at a surface temperature of 115° C. for 15 seconds.

Time taken from completion of exposure till to arrival at the preheating section was within 30 seconds.

### (Printing Method, Printing Durability, Resistance to Blanket Contamination, Storage Stability)

Printing was carried out in the same manner as above, and printing durability, resistance to blanket contamination, and resistance to background contamination after suspension of printing were evaluated in the same manner as above. The results are shown in Table 4.

TABLE 4

| | | | | Resistance to | |
|---|---|---|---|---|---|
| | | | | Background | |
| | | | Resistance to | Contamination | |
| Sam- | Sup- | Printing | Blanket | after Suspension | |
| ple | port | Durability | Contamination | of Printing | Re- |
| No. | No. | (Number) | (Ink Density) | (Ranking) | marks |
| 26 | 1 | 350000 | 0.05 | A | Inv. |
| 27 | 2 | 350000 | 0.05 | A | Inv. |
| 28 | 3 | 350000 | 0.05 | A | Inv. |
| 29 | 4 | 350000 | 0.05 | A | Inv. |
| 30 | 5 | 350000 | 0.05 | B | Inv. |
| 31 | 6 | 330000 | 0.05 | A | Comp |
| 32 | 7 | 350000 | 0.10 | C | Comp |
| 33 | 8 | 250000 | 0.05 | A | Comp |
| 34 | 9 | 350000 | 0.10 | C | Comp |
| 35 | 10 | 250000 | 0.05 | A | Comp |
| 36 | 11 | 350000 | 0.12 | C | Comp |
| 37 | 12 | 250000 | 0.05 | A | Comp |
| 38 | 13 | 300000 | 0.10 | D | Comp |
| 39 | 14 | 250000 | 0.05 | A | Comp |
| 40 | 15 | 300000 | 0.10 | C | Comp |
| 41 | 16 | 250000 | 0.10 | B | Comp |
| 42 | 17 | 300000 | 0.08 | C | Comp |
| 43 | 18 | 300000 | 0.05 | C | Comp |
| 44 | 19 | 250000 | 0.08 | C | Comp |
| 45 | 20 | 200000 | 0.05 | A | Comp |
| 46 | 21 | 200000 | 0.08 | C | Comp |
| 47 | 22 | 150000 | 0.15 | D | Comp |
| 48 | 23 | 100000 | 0.13 | D | Comp |
| 49 | 24 | 100000 | 0.18 | D | Comp |
| 50 | 25 | 100000 | 0.20 | D | Comp |

Inv.: Inventive,
Comp.: Comparative

As is apparent from Table 4, the inventive planographic printing plate material samples employing the support manufactured according to the manufacturing method of the invention provide high printing durability, high resistance to blanket contamination and high resistance to background contamination after suspension of printing.

(Preparation of Photopolymer Type Planographic Printing Plate Material Samples 51 through 75 for Infrared Laser (830 nm) Exposure)

The following light sensitive layer coating solution was coated on each of the supports 1 through 25 through a wire bar, and dried at 95° C. for 1.5 minutes to give a light sensitive layer with a dry thickness of 1.5 g/m², and then the protective layer coating solution described above was coated on the resulting light sensitive layer through an applicator and dried at 75° C. for 1.5 minutes to give a protective layer with a dry thickness of 1.7 g/m². Thus, photopolymerizable light sensitive planographic printing plate material samples were prepared.

(Light Sensitive Layer Coating Solution)

| | | |
|---|---|---|
| Polymer binder B-1 (described previously) | 40.0 | parts |
| Infrared absorbing dye D-5 (described below) | 2.5 | parts |
| N-Phenylglycine benzyl ester | 4.0 | parts |
| Addition polymerizable ethylenically | 40.0 | parts |
| unsaturated monomer M-3 (described previously) | | |
| Addition polymerizable ethylenically | 7.0 | parts |
| unsaturated monomer NK ESTER G (polyethylene glycol | | |
| dimethacrylate produced by Shinnakamura Kagaku Co., | | |
| Ltd.) | | |
| Cationically polymerizable compound C-1 | 8.0 | parts |
| (described previously) | | |
| Hindered amine compound | 0.1 | parts |
| (LS-770 produced by Sankyo Co., Ltd.) | | |
| Trihaloalkyl compound E-1 (described above) | 5.0 | parts |
| Phthalocyanine pigment | 7.0 | parts |
| (MHI #454 produced by Mikuni Sikisosha) | | |
| Fluorine-contained surfactant | 0.5 | parts |
| (F-178K produced by Dainippon Ink Kagaku Kogyo Co., | | |
| Ltd.) | | |
| Methyl ethyl ketone | 80 | parts |
| Cyclohexanone | 820 | parts |

D-5

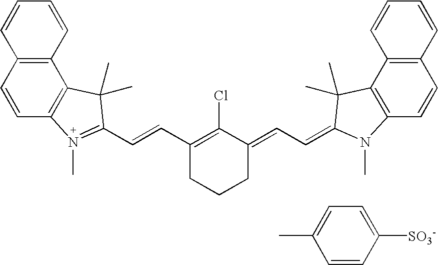

### (Image Formation)

Employing a plate setter (Trend Setter 3244 produced by Creo Co., Ltd.) installed with a 830 nm light source, each of the photopolymerizable light sensitive planographic printing plate material samples obtained above was imagewise exposed at exposure energy of 200 mJ/cm² and at a resolution of 2400 dpi (“dpi” means a dot number per 1 inch, i.e., 2.54 cm) to obtain an image with a screen line number of 175.

The image included a solid image and a dot image with a dot area of 1 to 99%.

Subsequently, the exposed sample was subjected to development treatment employing a CTP automatic developing machine (PHW 23-V produced by Technigraph Co., Ltd.) to obtain a planographic printing plate. Herein, the developing machine comprised a preheating section for preheating the exposed sample, a pre-washing section for removing the protective layer before development, a development section charged with developer as described above, a washing section for removing the developer remaining on the developed sample after development, and a gumming section charged with a gumming solution (a solution obtained by diluting GW-3, produced by Mitsubishi Chemical Co., Ltd., with water by a factor of 2) for protecting the surface of the developed sample. Thus, planographic printing plate samples 51 through 75 were obtained.

Herein, preheating was carried out at a surface temperature of 115° C. for 15 seconds.

Time taken from completion of exposure till to arrival at the preheating section was within 30 seconds.

### (Printing Method, Printing Durability, Resistance to Blanket Contamination, Storage Stability)

Printing was carried out in the same manner as above, and printing durability, resistance to blanket contamination, and resistance to background contamination after suspension of printing were evaluated in the same manner as above. The results are shown in Table 5.

TABLE 5

| | | | | Resistance to | |
|---|---|---|---|---|---|
| | | | | Background | |
| | | | Resistance to | Contamination | |
| Sam- | Sup- | Printing | Blanket | after Suspension | |
| ple | port | Durability | Contamination | of Printing | Re- |
| No. | No. | (Number) | (Ink Density) | (Ranking) | marks |
| 51 | 1 | 300000 | 0.05 | A | Inv. |
| 52 | 2 | 300000 | 0.05 | A | Inv. |
| 53 | 3 | 300000 | 0.05 | A | Inv. |
| 54 | 4 | 300000 | 0.05 | A | Inv. |
| 55 | 5 | 300000 | 0.05 | B | Inv. |
| 56 | 6 | 280000 | 0.05 | A | Comp |
| 57 | 7 | 300000 | 0.10 | C | Comp |
| 58 | 8 | 200000 | 0.05 | A | Comp |
| 59 | 9 | 300000 | 0.10 | C | Comp |
| 60 | 10 | 200000 | 0.05 | A | Comp |
| 61 | 11 | 300000 | 0.12 | C | Comp |
| 62 | 12 | 200000 | 0.05 | A | Comp |
| 63 | 13 | 250000 | 0.10 | D | Comp |
| 64 | 14 | 200000 | 0.05 | A | Comp |
| 65 | 15 | 250000 | 0.10 | C | Comp |
| 66 | 16 | 200000 | 0.10 | B | Comp |
| 67 | 17 | 250000 | 0.08 | C | Comp |
| 68 | 18 | 250000 | 0.05 | C | Comp |
| 69 | 19 | 200000 | 0.08 | C | Comp |
| 70 | 20 | 150000 | 0.05 | A | Comp |
| 71 | 21 | 150000 | 0.08 | C | Comp |
| 72 | 22 | 100000 | 0.15 | D | Comp |
| 73 | 23 | 50000 | 0.13 | D | Comp |
| 74 | 24 | 50000 | 0.18 | D | Comp |
| 75 | 25 | 50000 | 0.20 | D | Comp |

Inv.: Inventive,
Comp.: Comparative

As is apparent from Table 5, the inventive planographic printing plate material samples employing the support manufactured according to the manufacturing method of the invention provide high printing durability, high resistance to blanket contamination and high resistance to background contamination after suspension of printing.

(Preparation of Positive Working Planographic Printing Plate Material Samples 76 through 100 for Infrared Laser (830 nm) Exposure)

The following light sensitive layer coating solution was coated on each of the supports 1 through 25 through a wire bar, and dried at 95° C. for 1.5 minutes to give a light sensitive layer with a dry thickness of 1.5 g/m². Thus, light sensitive planographic printing plate material samples were prepared.

(Light Sensitive Layer Coating Solution)

| | | |
|---|---|---|
| Novolak resin (m-cresol/p-cresol = 60/40, | 1.0 | parts |
| Weight average molecular weight: 7,000, | | |
| containing 0.5% by weight of unreacted cresol) | | |
| Infrared absorbing dye D-5 (described above) | 0.1 | parts |
| Tetrahydrophthalic anhydride | 0.05 | parts |
| p-Toluene sulfonic acid | 0.002 | parts |
| Ethyl violet in which chloride ion is | 0.02 | parts |
| replaced by 6-hydroxy-β-naphthalene sulfonic | | |
| acid ion | | |
| Fluorine-contained surfactant | 0.5 | parts |
| (F-178K produced by Dainippon Ink Kagaku Kogyo | | |
| Co., Ltd.) | | |
| Methyl ethyl ketone | 12 | parts |

### (Image Formation)

Employing a plate setter (Trend Setter 3244 produced by Creo Co., Ltd.) installed with a 830 nm light source, each of the light sensitive planographic printing plate material samples obtained above was imagewise exposed at exposure energy of 150 mJ/cm² and at a resolution of 2400 dpi (“dpi” means a dot number per 1 inch, i.e., 2.54 cm) to obtain an image with a screen line number of 175.

The image included a solid image and a dot image with a dot area of 1 to 99%.

Subsequently, the exposed sample was subjected to development treatment employing a CTP automatic developing machine (PHW 23-V produced by Technigraph Co., Ltd.) to obtain a planographic printing plate. Herein, the developing machine comprised a preheating section for preheating the exposed sample, a pre-washing section for removing the protective layer before development, a development section charged with developer as described later, a washing section for removing the developer remaining on the developed sample after development, and a gumming section charged with a gumming solution (a solution obtained by diluting GW-3, produced by Mitsubishi Chemical Co., Ltd., with water by a factor of 2) for protecting the surface of the developed sample. Thus, planographic printing plate samples 52 through 68 were obtained.

Herein, preheating section was switched off, and water was not supplied to the pre-washing section for removing a protective layer before development. Time taken from completion of exposure till to arrival at the preheating section was within 30 seconds.

Developer (Aqueous solution containing the following additives)

| | | |
|---|---|---|
| Combination of non-reducing sugar and a base | 50.0 | g/liter |
| Potassium salt formed from D-sorbitol and K₂O | | |
| Orfin AK-02 | 0.15 | g/liter |
| (produced by Nissin Kagaku Co., Ltd.) | | |
| C₁₂H₂₅N(CH₂CH₂COONa)₂ | 1.0 | g/liter |

Water was added to make 1 liter of developer.

### (Printing Method, Printing Durability, Resistance to Blanket Contamination, Storage Stability)

Printing was carried out in the same manner as above, and printing durability, resistance to blanket contamination, and resistance to background contamination after suspension of printing were evaluated in the same manner as above. The results are shown in Table 6.

TABLE 6

| | | | | Resistance to | |
|---|---|---|---|---|---|
| | | | | Background | |
| | | | Resistance to | Contamination | |
| Sam- | Sup- | Printing | Blanket | after Suspension | |
| ple | port | Durability | Contamination | of Printing | Re- |
| No. | No. | (Number) | (Ink Density) | (Ranking) | marks |
| 76 | 1 | 250000 | 0.07 | A | Inv. |
| 77 | 2 | 250000 | 0.07 | A | Inv. |
| 78 | 3 | 250000 | 0.07 | A | Inv. |
| 79 | 4 | 250000 | 0.07 | A | Inv. |
| 80 | 5 | 250000 | 0.07 | B | Inv. |
| 81 | 6 | 230000 | 0.07 | A | Comp |
| 82 | 7 | 250000 | 0.12 | C | Comp |
| 83 | 8 | 150000 | 0.07 | A | Comp |
| 84 | 9 | 250000 | 0.12 | C | Comp |
| 85 | 10 | 150000 | 0.07 | A | Comp |
| 86 | 11 | 250000 | 0.14 | C | Comp |
| 87 | 12 | 150000 | 0.07 | A | Comp |
| 88 | 13 | 200000 | 0.12 | D | Comp |
| 89 | 14 | 150000 | 0.07 | A | Comp |
| 90 | 15 | 200000 | 0.12 | C | Comp |
| 91 | 16 | 150000 | 0.12 | B | Comp |
| 92 | 17 | 200000 | 0.10 | C | Comp |
| 93 | 18 | 200000 | 0.07 | C | Comp |
| 94 | 19 | 150000 | 0.10 | C | Comp |
| 95 | 20 | 100000 | 0.07 | A | Comp |
| 96 | 21 | 100000 | 0.10 | C | Comp |
| 97 | 22 | 50000 | 0.17 | D | Comp |
| 98 | 23 | 25000 | 0.15 | D | Comp |
| 99 | 24 | 25000 | 0.20 | D | Comp |
| 100 | 25 | 25000 | 0.22 | D | Comp |

Inv.: Inventive,
Comp.: Comparative

As is apparent from Table 6, the inventive planographic printing plate material samples employing the support manufactured according to the manufacturing method of the invention provide high printing durability, high resistance to blanket contamination and high resistance to background contamination after suspension of printing.

### (Preparation of On-press Development Type Planographic Printing Plate Material Samples 101 Through 125 for Infrared Laser (830 nm) Exposure)

### (Preparation of Hydrophilic Layer)

The components of the following hydrophilic layer composition were sufficiently mixed with stirring in a homogenizer, and filtered to obtain a hydrophilic layer coating solution with a solid content of 15% by weight.

The resulting hydrophilic layer coating solution was coated on each of the supports 1 through 25 through a wire bar, dried at 100° C. for 3 minutes to give a hydrophilic layer with a dry thickness of 2.0 g/m², and further subjected to aging treatment at 60° C. for 24 hours.

(Hydrophilic layer coating solution)

| | |
|---|---|
| Metal oxide particles having a light-to-heat conversion | 12.50 parts |
| capability, Black iron oxide particles | |
| ABL-207 (produced by Titan Kogyo K. K., octahedral | |
| form, average particle diameter: 0.2 μm, specific | |
| surface area: 6.7 m²/g, Hc: 9.95 kA/m, σs: | |
| 85.7 Am²/kg, σr/σs: 0.112) | |
| Colloidal silica (alkali type): | 60.62 parts |
| Snowtex XS (solid content: 20% by weight, produced | |
| by Nissan Kagaku Co., Ltd.) | |
| Aqueous 10% by weight sodium phosphate | 1.13 parts |
| dodecahydrate solution (Reagent produced by Kanto | |
| Kagaku Co., Ltd.) | |
| Aqueous 10% by weight solution of | 2.50 parts |
| watersoluble chitosan Flownack S (produced by | |
| Kyowa Technos Co., Ltd.) | |
| Aqueous 1% by weight solution of | 1.25 parts |
| Surfactant Surfinol 465 (produced by Air Products | |
| Co., Ltd.) | |
| Pure water | 22.00 parts |

Subsequently, the following image formation layer coating solution was coated on the hydrophillic layer, employing a wire bar, dried and further subjected to aging treatment.

### Image Formation Layer:

Dry thickness: 1.50 g/m²;
Drying condition: 55° C., 3 minutes;
Aging condition: 40° C., 24 hours

(Image Formation Layer Coating Solution)

| | |
|---|---|
| Aqueous polyurethane Takelac W-615 | 17.1 parts |
| (solid content: 35% by weight, produced by Mitsui Takeda | |
| Chemical Co., Ltd.) | |
| Aqueous block isocyanate Takenate | 7.1 parts |
| XWB-72-N67 (solid content: 45% by weight, produced | |
| by Mitsui Takeda Chemical Co., Ltd.) | |
| Aqueous solution (solid content: | 5.0 parts |
| 10% by weight) of sodium acrylate Aqualic DL522 | |
| (produced by Nippon Shokubai Co., Ltd.) | |
| Ethanol solution (solid content: | 30.0 parts |
| 1% by weight) of light-to-heat conversion dye ADS 830AT | |
| (produced by American Dye Source Co., Ltd.) | |
| Pure water | 40.8 parts |

### (Image Formation)

Employing a plate setter Trend Setter 3244 (produced by Creo Co., Ltd.), in which a 830 nm laser was installed, the planographic printing plate material sample obtained above was imagewise exposed at an exposure of 250 mJ/cm² and at a resolving degree of 2400 dpi to obtain an image with a screen line number of 175. Thus, planographic printing plate samples 101 through 125 were obtained.

The image pattern used for the exposure comprised a solid image and a dot image with 1 to 99% dot area.

### (Printing Method)

Each of the resulting planographic printing plate samples was mounted on the plate cylinder of a press (DAIYA1F-1 produced by Mitsubishi Jukogyo Co., Ltd.), and printing was carried out wherein a coat paper, printing ink (soybean oil-based ink “Naturalist 100” produced by Dainippon Ink Kagaku Kogyo Co., Ltd.) and dampening water (SG-51, H solution produced by Tokyo Ink Co., Ltd., Concentration: 1.5%) were used.

### (Printing Durability, Resistance to Blanket Contamination, Storage Stability)

Printing durability, resistance to blanket contamination, and resistance to background contamination after suspension of printing were evaluated in the same manner as above. The results are shown in Table 7.

TABLE 7

| | | | | Resistance to | |
|---|---|---|---|---|---|
| | | | | Background | |
| | | | Resistance to | Contamination | |
| Sam- | Sup- | Printing | Blanket | after Suspension | |
| ple | port | Durability | Contamination | of Printing | Re- |
| No. | No. | (Number) | (Ink Density) | (Ranking) | marks |
| 101 | 1 | 100000 | 0.05 | A | Inv. |
| 102 | 2 | 100000 | 0.05 | A | Inv. |
| 103 | 3 | 100000 | 0.05 | A | Inv. |
| 104 | 4 | 100000 | 0.05 | A | Inv. |
| 105 | 5 | 100000 | 0.05 | B | Inv. |
| 106 | 6 | 80000 | 0.05 | A | Comp |
| 107 | 7 | 100000 | 0.10 | C | Comp |
| 108 | 8 | 30000 | 0.05 | A | Comp |
| 109 | 9 | 100000 | 0.10 | C | Comp |
| 110 | 10 | 30000 | 0.05 | A | Comp |
| 111 | 11 | 100000 | 0.12 | C | Comp |
| 112 | 12 | 30000 | 0.05 | A | Comp |
| 113 | 13 | 50000 | 0.10 | E | Comp |
| 114 | 14 | 30000 | 0.05 | A | Comp |
| 115 | 15 | 50000 | 0.10 | D | Comp |
| 116 | 16 | 30000 | 0.10 | C | Comp |
| 117 | 17 | 50000 | 0.08 | D | Comp |
| 118 | 18 | 50000 | 0.05 | D | Comp |
| 119 | 19 | 30000 | 0.08 | D | Comp |
| 120 | 20 | 20000 | 0.05 | A | Comp |
| 121 | 21 | 20000 | 0.08 | D | Comp |
| 122 | 22 | 15000 | 0.15 | E | Comp |
| 123 | 23 | 15000 | 0.13 | E | Comp |
| 124 | 24 | 15000 | 0.18 | E | Comp |
| 125 | 25 | 15000 | 0.20 | E | Comp |

Inv.: Inventive,
Comp.: Comparative

As is apparent from Table 7, the inventive planographic printing plate material samples employing the support manufactured according to the manufacturing method of the invention provide high printing durability, high resistance to blanket contamination and high resistance to background contamination after suspension of printing.

1. A manufacturing method of an aluminum support for a planographic printing plate material, the method comprising the steps of:
(1) etching a surface on one side of an aluminum plate with an alkali solution;
(2) neutralizing the etched aluminum plate with an acidic solution;
(3) electrolytically surface-roughening the neutralized aluminum plate in an electrolytic solution containing mainly hydrochloric acid at current density of from 35 to 150 A/dm² and at a quantity of electricity of from 600 to 1500 A·second/dm², employing alternating current;
(4) carrying out the following step (4A) or (4B),
(4A) etching the surface-roughened aluminum plate with an alkali solution so that the dissolution amount of the aluminum is from 3 to 5 g/m², and then neutralizing the etched aluminum plate surface with an acidic solution or
(4B) etching the surface-roughened aluminum plate with an acidic solution containing mainly phosphoric acid so that the dissolution amount of the aluminum is from 3 to 5 g/m²;
(5) electrolytically surface-roughening the resulting aluminum plate in an electrolytic solution containing mainly hydrochloric acid at current density of from 15 to 30 A/dm² and at a quantity of electricity of from 100 to 400 A·second/dm², employing alternating current;
(6) desmutting smut produced on the aluminum plate surface during the step (5) in an acidic solution containing mainly phosphoric acid so that the amount of smut remaining undissolved is from 0.05 to 0.3 g/m²; and
(7) anodizing the desmutted aluminum plate, in that order, whereby a roughened surface is formed.

2. The manufacturing method of an aluminum support for a planographic printing plate material of claim 1, wherein the electrolytic solution containing mainly hydrochloric acid in steps (3) and (5) is an electrolytic solution containing a hydrochloric acid concentration of from 5 to 20 g/liter, an aluminum ion concentration of from 0.5 to 15 g/liter and an acetic acid concentration of 0 to 20 g/liter, whose temperature is from 15 to 40° C.

3. The manufacturing method of an aluminum support for a planographic printing plate material of claim 1, wherein the electrolytic solution containing mainly phosphoric acid in step (6) is an electrolytic solution containing a phosphoric acid concentration of from 25 to 450 g/liter and an aluminum ion concentration of from 0.01 to 10 g/liter, whose temperature is from 30 to 80° C.

4. The manufacturing method of an aluminum support for a planographic printing plate material of claim 1, wherein in step (1), the alkali solution contains 0.5 to 6 g/liter of NaOH, and the dissolution amount of the aluminum is from 2.5 to 5 g/m².

5. The manufacturing method of an aluminum support for a planographic printing plate material of claim 1, wherein the anodizing in step (7) is carried out in an acidic solution containing mainly sulfuric acid to form an anodization film with a coated amount of from 1 to 4 g/m².

6. The manufacturing method of an aluminum support for a planographic printing plate material of claim 1, wherein after the step (7), the anodized aluminum plate is subjected to sealing treatment or hydrophilization treatment.

7. An aluminum support manufactured according to the manufacturing method of an aluminum support for a planographic printing plate material of claim 1.

8. The aluminum support of claim 7, the aluminum support having a roughened surface with an arithmetic average roughness (Ra) of from 0.40 to 0.60 μm.

9. A planographic printing plate material comprising the aluminum support for a planographic printing plate material of claim 7, and provided thereon, an image formation layer.

10. The planographic printing plate material of claim 9, wherein the image formation layer is a thermosensitive image formation layer.

11. The planographic printing plate material of claim 9, wherein the image formation layer is a photopolymerizable image formation layer.

12. The planographic printing plate material of claim 9, wherein the image formation layer is capable of being subjected to on-press development.
